(19) United States
(12) Patent Application Publication
(10) Pub. No.: US 2023/0077437 A1
(43) Pub. Date: Mar. 16, 2023

(54) COEXTRUDED POLYMER FILM WITH SUCCESSIVE PEEL FORCE

(71) Applicant: 3M INNOVATIVE PROPERTIES COMPANY, St. Paul, MN (US)

(72) Inventors: Derek W. Patzman, Prior Lake, MN (US); Stephen A. Johnson, Woodbury, MN (US); William T. Fay, Woodbury, MN (US); Timothy J. Lindquist, Woodbury, MN (US); Onur Sinan Yordem, St. Paul, MN (US); Nathaniel I. Lehn, White Bear Lake, MN (US)

(21) Appl. No.: 17/800,058

(22) PCT Filed: Feb. 26, 2021
(86) PCT No.: PCT/IB2021/051632

§ 371 Date: Aug. 16, 2022

Related U.S. Application Data
(60) Provisional application No. 62/986,343, filed on Mar. 6, 2020.

(51) Int. Cl. B32B 37/15; B32B 27/08; B32B 27/20; B32B 27/30; B32B 27/32; B32B 27/36; B32B 27/40; B32B 7/06

(52) U.S. Cl. CPC B32B 37/153; B32B 27/08; B32B 27/20; B32B 27/302; B32B 27/308; B32B 27/32; B32B 27/365; B32B 27/40; B32B 7/06; B32B 2250/24; B32B 2307/412; B32B 2307/42; B32B 2307/748; B32B 2571/00

(57) ABSTRACT

This disclosure describes multilayer polymer films that are configured so that successive constituent layer packets may be delaminated in continuous sheet forms from the remaining film. This disclosure further describes compositions, materials, and methods for minimizing the likelihood of removing multiple layer packets together including by increasing the peel force between layer packets. In some embodiments, that the peel force becomes successively greater from the interface between the first layer packet and the second layer packet to the interface between the next to last ((n−1)^{th} layer packet) and the last (n^{th} layer packet).

### SUMMARY OF THE INVENTION

This disclosure describes multilayer polymer films that are configured so that successive constituent layer packets may be delaminated in continuous sheet forms from the remaining film. Due to the successive peel force between the layer packets, the likelihood of removing multiple layer packets together—instead of a single layer packet at a time—may be minimized.

In one aspect, this disclosure describes a film that includes a co-extruded stack of polymer layers. The polymer layers are organized into layer packets, each layer packet including a first layer A, a second layer B, and a third layer C. Layer B is disposed between layer A and layer C. The film further includes a packet interface between layers A and C of adjacent layer packets, the packet interface exhibiting a first peel force of 1 gram/inch or greater; a layer interface between adjacent layers A and B, the layer interface exhibiting a second peel force that is greater than the first peel force; and a layer interface between adjacent layers B and C, the layer interface exhibiting a third peel force that is greater than the first peel force. The layer packets are separately irreversibly peelable from a remainder of the stack. The co-extruded stack of polymer layers includes at least a first layer packet and a second layer packet.

In some embodiments, each layer packet includes a conformable layer including layer B and layer C, and the thickness of the conformable layer of the second layer packet is greater than the thickness of the conformable layer of the first layer packet.

In some embodiments, the thickness of layer A of the second layer packet is less than the thickness of layer A of the first layer packet.

In another aspect, this disclosure describes a film that includes a co-extruded stack of polymer layers. The polymer layers are organized into layer packets, each layer packet including a first layer A, a second layer B, and a third layer C. Layer B is disposed between layer A and layer C. Layer A of the film comprises a first polymer composition A, layer B of the film comprises a second polymer composition B, and layer C of the film comprises a third polymer composition C.

Polymer composition A includes a polyester, a co-polyester, a polyolefin, a poly-alpha-olefin, a polymethacrylate, a polycarbonate, a polycarbonate alloy, a polyurethane, an aliphatic polyester, polyhydroxybutyrate, polyhydroxysuccinate, a styrenic copolymer, a silicone, a silicone thermoplastic, an acrylic, or a copolymer or blend thereof. Polymer composition B includes a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof. Polymer composition C includes a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof.

The layer packets are separately irreversibly peelable from a remainder of the stack. The co-extruded stack of polymer layers includes at least a first layer packet and a second layer packet.

In some embodiments, each layer packet includes a conformable layer comprising layer B and layer C, and the thickness of the conformable layer of the second layer packet is greater than the thickness of the conformable layer of the first layer packet.

In some embodiments, the thickness of layer A of the second layer packet is less than the thickness of layer A of the first layer packet.

In another aspect, this disclosure describes a face shield including a multilayer polymer film as described herein.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

Unless otherwise specified, “a,” “an,” “the,” and “at least one” are used interchangeably and mean one or more than one.

As used herein, the term “or” is generally employed in its usual sense including “and/or” unless the content clearly dictates otherwise.

The term “and/or” means one or all of the listed elements or a combination of any two or more of the listed elements.

Also herein, the recitations of numerical ranges by endpoints include all numbers subsumed within that range (for example, 1 to 5 includes 1, 1.5, 2, 2.75, 3, 3.80, 4, 5, etc.).

Herein, “up to” a number (for example, up to 50) includes the number (for example, 50).

The term “in the range” or “within a range” (and similar statements) includes the endpoints of the stated range.

For any method disclosed herein that includes discrete steps, the steps may be conducted in any feasible order. And, as appropriate, any combination of two or more steps may be conducted simultaneously.

All headings are for the convenience of the reader and should not be used to limit the meaning of the text that follows the heading, unless so specified.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

Unless otherwise indicated, all numbers expressing quantities of components, molecular weights, and so forth used in the specification and claims are to be understood as being modified in all instances by the term “about.” As used herein in connection with a measured quantity, the term “about” refers to that variation in the measured quantity as would be expected by the skilled artisan making the measurement and exercising a level of care commensurate with the objective of the measurement and the precision of the measuring equipment used. Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

The above summary of the present invention is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE FIGURES

FIG. 1A is a schematic side or sectional view of a layer packet of a polymer film. FIG. 1B-FIG. 1E are schematic side or sectional views of exemplary polymer films including layer packets and configured for successive irreversible delamination.

FIG. 2A is a schematic side or sectional view of a polymer film configured for successive irreversible delamination. FIG. 2B-FIG. 2D are schematic side or sectional views of the polymer film of FIG. 2A as successive layer packet are delaminated and peeled away from the film.

FIG. 3A is a schematic side or sectional view of a polymer film including a base layer and configured for successive irreversible delamination. FIG. 3B-FIG. 3E are schematic side or sectional views of the polymer film of FIG. 3A as successive layer packet are delaminated and peeled away from the film.

FIG. 4 is a schematic representation of a manufacturing system in which three polymer materials are coextruded to form a multilayered polymer film.

FIG. 5 is a schematic representation of film processing equipment that can be used to stretch a cast multilayered polymer film.

FIG. 6 is a schematic front view of a face shield comprising a polymer film including layer packets configured for successive irreversible delamination.

FIG. 7 is a chart of peel force in grams per inch (g/inch) of layers of polymer films undergoing successive irreversible delamination in grams per inch (g/inch), prepared and measured as described in Example 1.

FIG. 8 is a chart of peel force in grams per inch (g/inch) of layers of polymer films undergoing successive irreversible delamination in grams per inch (g/inch), prepared and measured as described in Comparative Example 1.

### DETAILED DESCRIPTION OF ILLUSTRATIVE EMBODIMENTS

This disclosure describes polymer material combinations which, when incorporated in a coextruded stack of polymer layers, may be used to produce a multilayered polymer film containing numerous layer packets which may be delaminated or peeled away, one layer packet at a time, from the remaining film. A stack of polymer layers are arranged or organized to form the layer packets, each layer packet having at least two of the polymer layers. In contrast to the films of U.S. Application Nos. 2015/0183178A1, 2019/0248117A1, and 2019/0248118A1, the films disclosed herein exhibit a gradient peel force between the layer packets throughout the stack of polymer layers. The gradient may be increasing such that the peel force becomes successively greater from the interface between the first layer packet and the second layer packet to the interface between the next to last ((n−1)^{th} layer packet) and the last (n^{th} layer packet). The gradient peel force decreases the likelihood that multiple layer packets are removed together—instead of a single layer packet being removed from the stack of polymer layers.

These films may be made by coextruding all the polymer layers in the stack, with no need to laminate separately manufactured films or layers in order to construct the stack. This construction allows the individual layer packets (which may be sequentially peeled away) to be made much thinner than could otherwise be done, such that more separately peelable sheets may be included in a film of a specified overall thickness. Coextruded layers are also less susceptible to contamination during manufacturing than layers that are separately made and then laminated together.

The films may also be made without the need for any pressure sensitive adhesives, or other kinds of adhesives, in the stack of polymer layers. The absence of adhesives may simplify manufacture and also produce film surfaces, which are interior to the film in the initial finished product but that become exterior surfaces as layer packets are peeled away during use, that are more pristine than may be achieved in a film made by using separate lamination steps.

Some of the features of the peelable polymer films, including, for example, the composition of the polymers of the polymer layers in the layer packets or the methods of making the polymer stacks, described in commonly assigned U.S. Publication Nos. 2015/0183178A1, 2019/0248117A1, and 2019/0248118A1 and International Publication No. WO 2019/032635 may be suitable for use with the films disclosed herein that exhibit a gradient peel force between the layer packets throughout the stack of polymer layers.

Specific embodiments of the invention will now be described with reference to the accompanying drawings. This invention may, however, be embodied in many different forms and should not be construed as limited to the embodiments described in the drawings. In the drawings, like numbers refer to like elements.

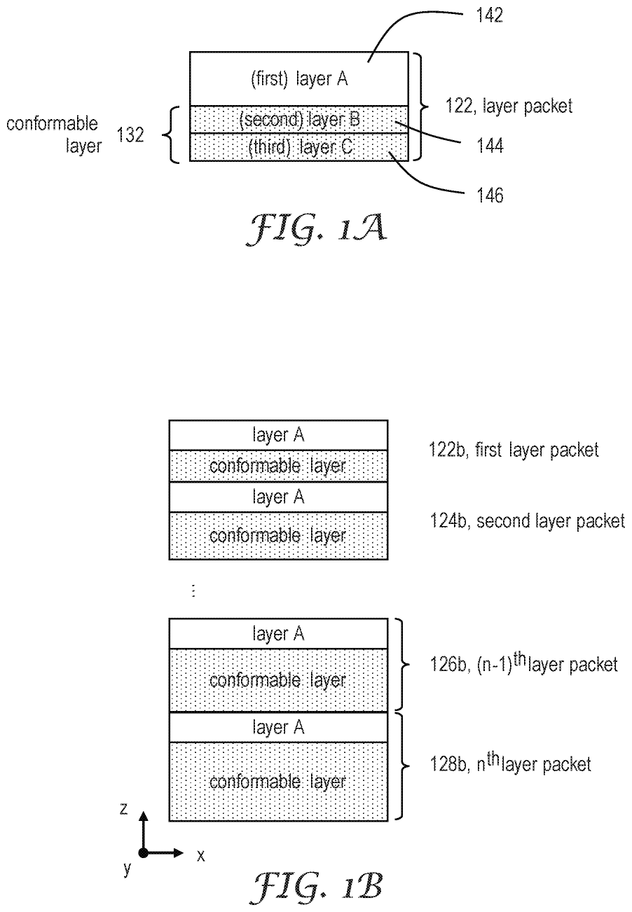

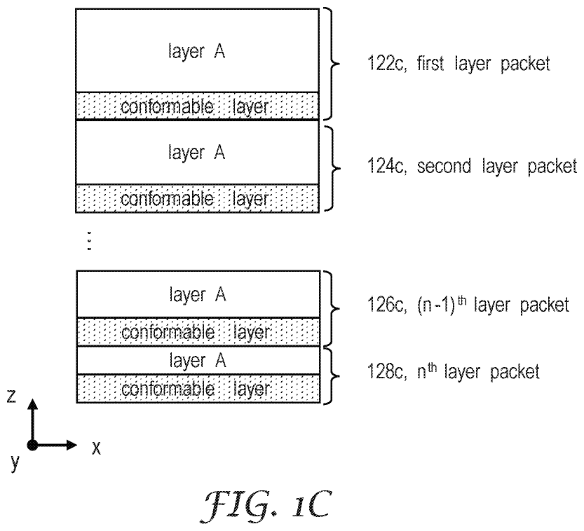

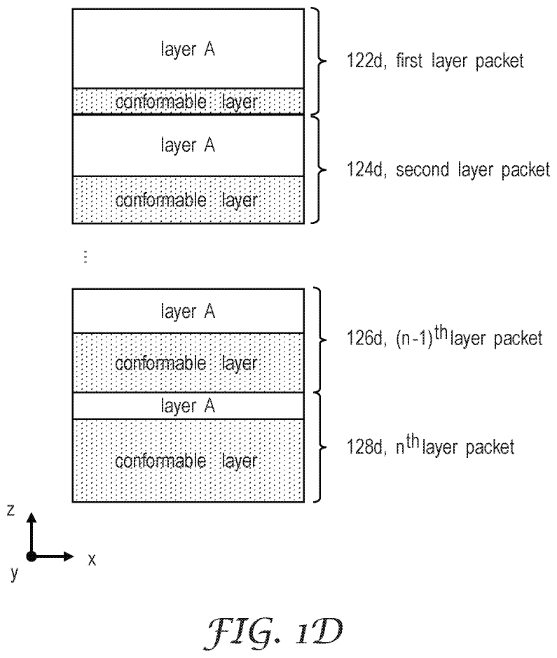

Exemplary polymer layers of a layer packet are shown in FIG. 1A. As shown in FIG. 1A, each layer packet includes a first layer A, a second layer B, and a third layer C, labeled as 142, 144, and 146, respectively. Layer B 144 is disposed between layer A 142 and layer C 146. Layer B 144 and Layer C 146 may together form a conformable layer 132. In some embodiments, layer B 144 and layer C 146 may have the same composition and, in those embodiments, the layer packet may be considered to include two layers, layer A 142 and a conformable layer.

In some embodiments, as shown in FIG. 1A, the conformable layer 132 may include a layer B 144 and a layer C 146 having the same thickness. In some embodiments, however, when the co-extruded stack of polymer layers exhibits a gradient in the thickness of the conformable layer, as further described below, layer B may increase in thickness while the thickness of layer C remains constant or layer C may increase in thickness while the thickness of layer B remains constant, or layer B and layer C may both increase in thickness such that the ratio of the thickness of layer B to the thickness of layer C remains constant throughout the depth of the stack of polymer layers. Layer A, layer B, and layer C may each be formed of any suitable polymer composition. In some embodiments, layer A may include a first polymer composition A, layer B may include a second polymer composition B, and layer C may include a third polymer composition C. In some embodiments, polymer composition B may be different from polymer composition A, and polymer composition C may be different from polymer composition A. In other embodiments, polymer composition C may be different from polymer composition A and polymer composition B. In some embodiments, polymer composition B may be different from polymer composition A, and polymer composition C may be different from polymer composition A, but polymer composition B may be the same as polymer composition C.

In some embodiments, the polymer compositions A, B, and C are preferably melt processable at a temperatures of at least 204° C. (400° F.).

In some embodiments, the polymer compositions A, B, or C, or a combination thereof, may be polyester-based materials, but other suitable materials can also be used. For example, polymer composition A may be or may comprise polyesters, co-polyesters, polyolefins, poly-alpha-olefins, polymethacrylates, polycarbonates, polycarbonate alloys, polyurethanes, aliphatic polyesters such as polylactic acid, polyhydroxybutyrate, polyhydroxysuccinate, styrenic copolymers, silicones, silicone thermoplastics, acrylics, or copolymers and/or blends thereof. In an exemplary embodiment, polymer composition A may be or may comprise polyethylene terephthalate (PET). In some embodiments, polymer composition B or polymer composition C or both, may be or may comprise polyesters, polyolefins, poly-alpha-olefins, polymethacrylates, polycarbonates, polycarbonate alloys, aliphatic polyesters such as polyhydroxybutyrate, polyethylene succinate, polylactic acids, styrenic block copolymers, silicones, or copolymers and/or blends thereof. Exemplary polyolefins include polypropylene and polyethylene. In an exemplary embodiment, polymer composition B or polymer composition C or both may be or may comprise a copolymer based on styrene and ethylene/butylene. For example, polymer composition B or polymer composition C or both may be or may comprise KRATON G1645 (Kraton Corporation, Houston, Tex.), a linear, triblock copolymer based on styrene and ethylene/butylene. Copolymers may be block or random or a combination thereof.

In some embodiments, polymer composition B and either polymer composition A or polymer composition C are preferably polyester-based materials. As further described in US Publication No. 2019/0248117, proper incorporation of polyester and non-polyester-based material combinations into layer B, or layer A or layer C of a layer packet can cause the layer packet to preferentially delaminate along an interface between adjacent layer packets (for example, between layer C and layer A) instead of within a layer packet (for example, between layer A and layer B or layer B and layer C).

With respect to the three-layer embodiment of FIG. 1A, delamination between layer C and layer A may be achieved by making the attachment of layer C to layer A weaker than the attachment of the layer C to layer B, and weaker than the attachment of layer B to layer A. In some embodiments, preferential delamination between layer packets (for example, between adjacent layer C and layer A) may be achieved by using a blend of polypropylene copolymer with a suitable amount of another resin for polymer composition C. For example, polymer composition C may be a miscible blend of propylene copolymer and styrenic block copolymer, or a miscible blend of propylene copolymer and an ethylene alpha olefin copolymer, or a miscible blend of propylene copolymer and an olefin block copolymer. In cases where polymer composition C is a miscible blend of propylene copolymer and styrenic block copolymer, polymer composition B may be an immiscible blend of copolyester and an olefin and polymer composition A may be a semi-crystalline polyester optionally blended with an amorphous copolyester, or polymer composition B may be an amorphous copolyester and polymer composition A may be a semi-crystalline polyester. When polymer composition A is a blend of semi-crystalline polyester with an amorphous copolyester, the composition may include up to 50% amorphous copolyester, but, in some embodiments, including when cost is a factor, up to 20% amorphous copolyester may be preferred.

In some cases, polymer composition C may be at least partially miscible with the polymer composition B, and polymer composition B may be at least partially miscible with the polymer composition A, but polymer composition C may not be miscible with the polymer composition A. As used herein, a given polymer composition which is an immiscible blend of polymers, such as any of polymer compositions A, B, or C, may be said to be at least partially miscible with another polymer composition if at least one component of the immiscible blend is miscible with the another polymer composition (or with at least one component of the another polymer composition if the another polymer composition is also an immiscible blend or a block copolymer, in which case “component” refers to the individual block domains of the block copolymer). As already indicated above, even though attachment between the polymer A layers and the polymer C layers may be weakest, such attachment may still be greater than zero. For example, the peel force at the packet interfaces (between adjacent layer A and layer C) may be at least 1 gram/inch, or at least 2 grams/inch. Peel force units of grams/inch (or grams/inch width), abbreviated g/in, are sometimes referred to as grams per linear inch (abbreviated gli). One (1) g/in equals 0.3860886 N/m.

For the purposes of the present disclosure, the terms “miscible,” “miscibility,” and the like, are not meant in the absolute sense of requiring that the two or more polymers in question form one homogeneous phase of spatially-constant composition, but rather, in the relative sense that there be sufficient inter-diffusion of the two or more polymers to provide significant interactions of entanglements across the interface between phases, and/or what is sometimes referred to in the literature as an “interphase” between the layers. Miscibility in this relative sense is also sometimes referred to in the polymer science literature as “compatibility” or “partial miscibility.” Further, a homopolymer or random copolymer, for instance, may be said to exhibit miscibility in this sense with a block copolymer if it has such ability to interact with the domains of just one block of the block copolymer, even if the homopolymer or copolymer is entirely immiscible with the domains of the other block(s) of the block copolymer.

In addition to miscibility differences, the presence of macromolecular orientation, or crystallinity, or both, in at least one component of adjacent layers (for example, in adjacent layer A or layer B or both) may affect the peel force of the adjacent layers due to a decrease in intermolecular entanglement across the interface between the two layers. Intermolecular entanglement may be caused by decreased mobility of polymer molecules which are molecularly oriented (rather than in random coil configuration), involved in structured crystallites (rather than being in an amorphous state), or both. In other words, morphology (such as degree of crystallinity), as well as composition, can be used to affect the relative peel force among pairs of layers.

For example, the peel force between adjacent layers may be increased by increasing molecular orientation or crystallinity or both. In some embodiments, at least one of layer A, layer B, or layer C includes a crystalline or semi-crystalline polymer. In one embodiment, layer A includes a crystalline or semi-crystalline polymer.

In some embodiments, polymer compositions A, B, and C may independently include one or more polymers selected from polyesters, polyolefins, poly-alpha-olefins, polymethacrylates, polycarbonates, polycarbonate alloys, polyurethanes, polylactic acid, polyhydroxybutyrate, polyhydroxysuccinate, styrenic copolymers, silicones, or copolymers or blends thereof.

In some embodiments, polymer composition A includes a polyester, a copolyester, an acrylic, or a silicone thermoplastic, or a combination (including, for example, a blend) thereof. In some embodiments, polymer composition A may be selected from polyester, copolyesters, acrylics, and silicone thermoplastics. In some embodiments, polymer composition A includes a semi-crystalline polyester. In an exemplary embodiment, polymer composition A includes polyethylene terephthalate (PET).

In some embodiments, polymer composition B includes a copolyester, PMMA, co-PMMA, a styrenic block copolymer, polypropylene, or silicone polyoxamides, or a combination (including, for example, a blend) thereof. In some embodiments, polymer composition B may be selected from a variety of polymers and polymer blends, including but not limited to copolyesters, PMMA, co-PMMA, styrenic block copolymers, polypropylene, and silicone polyoxamides, In some embodiments, polymer composition B includes a copolyester, or a styrenic block copolymer, or a combination (including, for example a blend) thereof. In an exemplary embodiment, polymer composition B includes a copolymer based on styrene and ethylene/butylene including, for example, KRATON G1645 (Kraton Corporation, Houston, Tex.), a linear, triblock copolymer based on styrene and ethylene/butylene.

In some embodiments, polymer composition C may be selected from blends of olefins such as polypropylene or polyethylene blended with suitable amounts of a styrenic block copolymer, or an ethylene alpha olefin copolymer, or an olefin block copolymer. In some embodiments, polymer composition C includes an olefin, or a styrenic block copolymer, or a combination (including, for example a blend) thereof. In an exemplary embodiment, polymer composition C includes a copolymer based on styrene and ethylene/butylene including, for example, KRATON G1645 (Kraton Corporation, Houston, Tex.), a linear, triblock copolymer based on styrene and ethylene/butylene.

Note that not all combinations of the aforementioned suitable compositions for the different polymer compositions will yield the desired results, and judgment must be used to identify appropriate combinations of the polymer materials for use in the different layer types to achieve the desired functionality and delamination characteristics. For example, the polymer composition A may be or comprise a semi-crystalline polyester, polymer composition C may be or comprise a polypropylene blended with a styrenic block copolymer, an ethylene alpha olefin copolymer, or an olefin block copolymer, and polymer composition B may be or comprise a copolyester. In another example, the polymer composition A may be or comprise polymethylmethacrylate (PMMA) or co-PMMA, polymer composition C may be or comprise a blend of polypropylene and a styrenic block copolymer, and polymer composition B may be a blend of PMMA or co-PMMA with a styrenic block copolymer or polypropylene. In still another example, polymer composition A may be or comprise a silicone polyoxamide, polymer composition C may be or comprise polypropylene and a styrenic block copolymer, and polymer composition B may be a styrenic block copolymer.

In some embodiments, polymer composition C is at least partially miscible with polymer composition B. In some embodiments, polymer composition B is at least partially miscible with polymer composition A. In some embodiments, polymer composition C is not miscible with polymer composition A. In some embodiments, polymer composition C is at least partially miscible with polymer composition B, and polymer composition B is at least partially miscible with polymer composition A, and polymer composition C is not miscible with polymer composition A.

One or more optional additives may also be included in some or all of the layers. The optional additive include, for example, a UV light stabilizer, an antimicrobial agent, suitably sized beads or other particles, and/or other desired additive(s). In some embodiments, the additive may be dispersed in layer A of each layer packet, but may not be present in any of the other polymer layers. In some embodiments, the additive may be present as a continuous or co-continuous phase material. In some embodiments, the additive may also be soluble in one, some, or all of the layers of the layer stack.

In some embodiments, layer A, layer B, or layer C, or a combination thereof include one or more ultraviolet (UV) light stabilizers. In some embodiments, layer A, layer B, or layer C, or a combination thereof does not include an UV light stabilizer.

In some embodiments, layer A, layer B, or layer C, or a combination thereof include one or more organic antimicrobial agents. In some embodiments, layer A, layer B, or layer C, or a combination thereof does not include an antimicrobial agent.

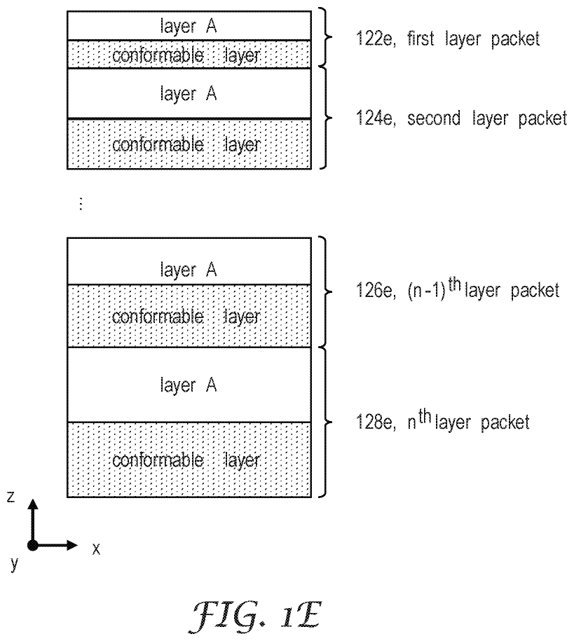

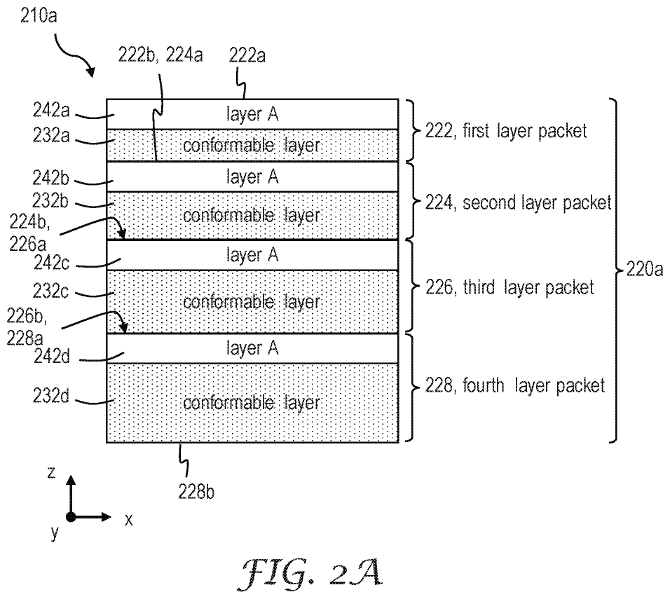

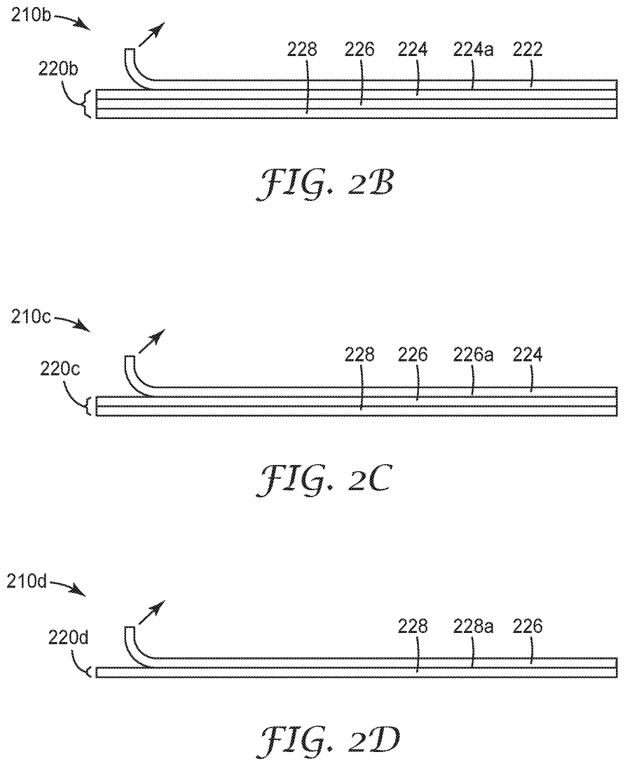

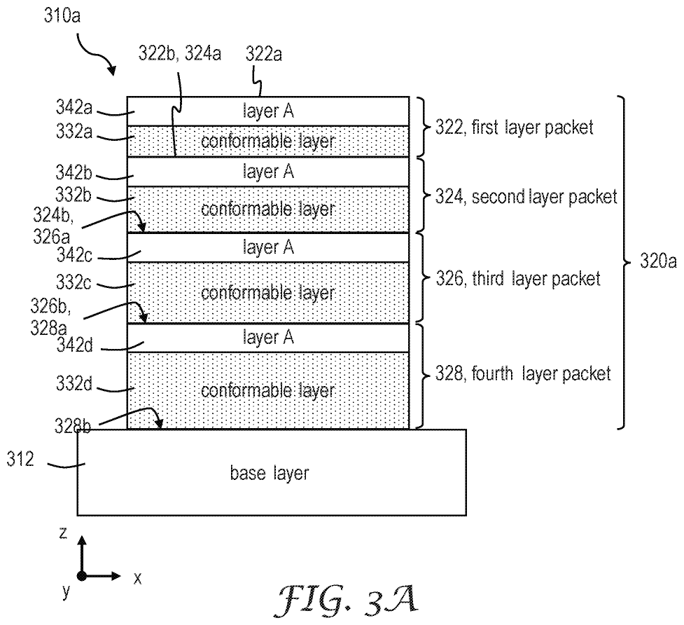

In some embodiments, layer A and layer B, or layer A and layer C, or layer B and layer C, or some combination thereof may be oriented. Such oriented layers may have a minimum level of birefringence including, for example, a birefringence of 0.03 or greater, 0.04 or greater, 0.05 or greater, 0.07 or greater, or 0.10 or greater. In this regard, a given material or material layer is said to be birefringent when it has a refractive index for light polarized along one direction that differs from a refractive index for light polarized along a different direction. The “birefringence” of the material or material layer is then the maximum difference between such refractive indices. Such maximum difference may occur in some cases between two orthogonal axes that both lie in the plane of the film (for example, the x- and y-axes in FIG. 1B-FIG. 1E, FIG. 2, and FIG. 3), and in other cases between two orthogonal axes one of which lies in the plane of the film and the other of which is perpendicular to the plane of the film (for example, the x- and z-axes in FIG. 1B-FIG. 1E, FIG. 2, and FIG. 3).

FIG. 1A exemplifies three-layer (A-B-C) layer packets. The layers may be organized differently or other layer types (for example, polymer layers D, E, and so forth) may be added to the stack, such that the layer packets contain more than three individual polymer layers. For example, the A, B, C layers may be arranged in an A, B, A, B, C, A, B, A, B, C, etc., arrangement, such that each layer packet is a 5-layer group (A-B-A-B-C) of polymer layers. In this case the attachment of the C layers to the A layers would again be made to be substantially weaker than the attachment of the C layers to the B layers, and weaker than the attachment of the B layers to the A layers, so that delamination surfaces would be formed at packet interfaces between the C layers and the A layers. However, to ensure the film does not simply fall apart, attachment of the C layers to the A layers is characterized by a peel force greater than zero. For example, the peel force between adjacent C layers and A layers may be 0.8 grams/inch or greater, 1 gram/inch or greater, 1.5 gram/inch or greater, or 2 grams/inch or greater.

In one example, a polymer layer D, made of a polymer composition D different than compositions A, B, and C, may be added to the layer stack. According to an embodiment, the polymer compositions are coextrudable with each other, such that the entire layer stack may be coextruded in a single operation. In some embodiments, polymer composition D is preferably melt processable at a temperatures of at least 204° C. (400° F.). In some cases, none of the compositions A, B, C, D are pressure sensitive adhesives (PSAs), or other types of adhesives.

Preferably, any additional polymer layers are added in such a way that the modified stack may be made by a single coextruding process, and that sheets or layer packets can be successively irreversibly delaminated from the remainder of the layer stack of the multilayered polymer film. The modified stack that includes additional polymer layers may remain free of adhesive or PSA.

In some embodiments, any or all of the polymer layers A, B, C, D, etc. may be oriented. Such oriented layers may have a minimum level of birefringence including, for example, a birefringence of 0.03 or greater, 0.04 or greater, 0.05 or greater, 0.07 or greater, or 0.10 or greater.

As shown in FIG. 1B-FIG. 1E, the layer packets 122b, 122c, 122d, 122e, 124b, 124c, 124d, 124e, 126b, 126c, 128b, 128c may be organized into a co-extruded stack of polymer layers. Co-extruded stacks of polymer layers may include as few as two layer packets but, as shown in FIG. 1B-FIG. 1E, the stack may include any suitable number (n) of layer packets. The number of layer packets may be selected by a person having skill in the art based on the ease of manufacturing or the intended use of the co-extruded stack of polymer layers. In some embodiments, the co-extruded stack of polymer layers includes n layer packets. In some embodiments, the n^{th} layer packet is the second, third, fourth, fifth, sixth, seventh, eighth, ninth, tenth, eleventh, twelfth, thirteenth, fourteenth, fifteenth, sixteenth, seventeenth, eighteenth, nineteenth, twentieth, or twenty-first layer packet. One benefit of making the polymer layers in a single coextrusion operation is that up to twenty or more very thin layer packets, which may be removed sequentially in continuous sheet form, may be incorporated into a polymer film.

In some embodiments, the peel force between adjacent layer packets (that is, at the packet interface) increases from one packet interface to the next. Such increasing peel force may help prevent more than one layer packet getting peeled at once. However, even at the last packet interface, the peel force is smaller than the peel force within a given packet (that is, at layer interfaces within a packet). In some embodiments, a co-extruded stack of polymer layers may exhibit a peel force gradient from the first layer packet to the n^{th} layer packet. For example, the peel force at the packet interface between layer A of the second layer packet and layer C of the first layer packet may be less than the peel force between layer A of the third layer packet and layer C of the second layer packet. The peel force at the packet interface between layer A of the second layer packet and layer C of the first layer packet may be less than the peel force between layer A of an n^{th} layer packet and layer C of an (n−1)^{th} layer packet. The peel force at each successive packet interface may be greater than the peel force at the previous packet interface.

In some embodiments, the peel force at the packet interface between layer A of the second layer packet and layer C of the first layer packet is at least 5, at least 10, at least 100, or at least 250 times less than the peel force between layer A of an n^{th} layer packet and layer C of an (n−1)^{th} layer packet. In some embodiments, the peel force at the packet interface between layer A of the second layer packet and layer C of the first layer packet is up to 500, up to 250, up to 100, or up to 10 times less than the peel force between layer A of an n^{th} layer packet and layer C of an (n−1)^{th} layer packet. For example, in an exemplary embodiments, the peel force at the packet interface between layer A of the second layer packet and layer C of the first layer packet is 500 times less than the peel force between layer A of an n^{th} layer packet and layer C of an (n−1)^{th} layer packet.

In some embodiments, the peel force at each successive packet interface increases by at least 0.5 percent, at least 1 percent, at least 5 percent, at least 10 percent, at least 20 percent, at least 50 percent, or at least 100 percent from the previous packet interface. In some embodiments, the peel force at each successive packet interface may increase by up to 1 percent, up to 5 percent, up to 10 percent, up to 20 percent, up to 50 percent, up to 100 percent, up to 1000 percent, up to 10,000 percent, or up to 50,000 percent from the previous packet interface.

In some embodiments, the co-extruded stack of polymer layers may exhibit a gradient in the thickness of layers A, B, or C, or a combination thereof from the first layer packet to the n^{th} layer packet. In one embodiment, the co-extruded stack of polymer layers exhibits a gradient in the thickness of layers A. The gradient may be a reduction in the thickness of the A layers in the stack from the first layer packet to the n^{th} layer packet. In one embodiment, the co-extruded stack of polymer layers exhibits a gradient in the thickness of layers B or layers C or the combined thickness of layers B and C. The gradient may be an increase in the thickness of layers B or layers C or the combined thickness of layers B and C in the stack from the first layer packet to the n^{th} layer packet.

In an exemplary embodiment, shown in FIG. 1B, the co-extruded stack of polymer layers exhibits a gradient in the thickness of a conformable layer (including layers B and C) from the first layer packet to the n^{th} layer packet. In some embodiments, as shown in FIG. 1B, the thickness of the conformable layer of the first layer packet 122b is less than the thickness of the conformable layer of the n^{th} layer packet 128b. The thickness of the conformable layers (for example, combined layers B and C) may successively increase throughout the stack from the first layer packet to the n^{th} layer packet.

In some embodiments, the thickness of the conformable layer of the first layer packet may be at least 1.1 times, at least 1.2 times, at least 1.5 times, or at least 2 times less than the thickness of the conformable layer of the n^{th} layer packet. In some embodiments, the thickness of the conformable layer of the first layer packet may be up to 2 times, up to 5 times, or up to 10 times less than the thickness of the conformable layer of the n^{th} layer packet. According to an embodiment and as described in Example 1, as the thickness of each conformable layer increases (compared to the previous conformable layer), the peel force from one packet interface to the next increases. In an exemplary embodiment, the thickness of the conformable layer of the first layer packet may be 3 times less than the thickness of the conformable layer of the n^{th} layer packet.

In some embodiments, the thickness of the conformable layer of each successive layer packet increases by at least 5 percent, at least 10 percent, at least 15 percent, at least 20 percent, at least 25 percent, or at least 30 percent. In some embodiments, the thickness of the conformable layer of each layer packet increases by up to 50 percent, up to 100 percent, up to 200 percent, up to 500 percent, or up to 1000 percent. In some embodiments, the thickness of the conformable layer of each successive layer packet increases by 5 percent to 500 percent, by 10 percent to 200 percent, or by 15 percent to 100 percent. As described in Example 1, a 20 percent change in the thickness of the conformable layer from one layer to the next may, in some embodiments, provide approximately 0.5 On difference in peel force.

In some embodiments, the thickness of the sum of all of the conformable layers in the stack of polymer layers may be at least 10 micrometers, at least 15 micrometers, at least 20 micrometers, at least 25 micrometers (about 1.0 mil), at least 30 micrometers, at least 35 micrometers, at least 40 micrometers (about 1.6 mil), at least 45 micrometers, at least 50 micrometers (about 2.0 mil), at least 55 micrometers, at least 60 micrometers, at least 65 micrometers (about 2.5 mil), at least 70 micrometers, at least 80 micrometers, at least 90 micrometers, or at least 100 micrometers. In some embodiments, the thickness of the sum of all of the conformable layers in the stack of polymer layers may be up to 300 micrometers, up to 200 micrometers, up to 100 micrometers, up to 90 micrometers, up to 80 micrometers, up to 70 micrometers, up to 65 micrometers (about 2.5 mil), up to 60 micrometers, up to 55 micrometers, up to 50 micrometers (about 2.0 mil), up to 45 micrometers, up to 40 micrometers (about 1.6 mil), up to 35 micrometers, up to 30 micrometers, up to 25 micrometers (about 1.0 mil). In some embodiments, the thickness of the sum of all of the conformable layers in the stack of polymer layers may be from 20 micrometers to 200 micrometers, or from 25 micrometers to 100 micrometers.

As described in Example 1, the thickness of each of the conformable layers in the stack of polymer layers may be added together to form a “sum of the thickness of the conformable layers.” As sum of the thickness of the conformable layers increases, the peel force difference from layer packet to layer packet increases. In some embodiments, the upper end of sum of the thickness of the conformable layers may be dictated by extrusion and/or film orientation capability.

In some embodiments, the co-extruded stack of polymer layers may exhibit both a peel force gradient and a thickness gradient. In some embodiments, a gradient in peel force between the layer packets throughout the stack of polymer layers is achieved by varying the ratio of the thickness of the conformable layer to the thickness of layer A throughout the stack. In some embodiments, either the thickness of layer A, the thickness of layer B, the thickness of layer C, or a combination thereof is varied.

In an exemplary embodiment, shown in FIG. 1C, the co-extruded stack of polymer layers exhibits a gradient in the thickness of layer A from the first layer packet to the n^{th} layer packet. In some embodiments, as shown in FIG. 1C, the thickness of layer A of the first layer packet 122c is less than the thickness of layer A of the n^{th} layer packet 128c. The thickness of layer A decreases successively in adjacent layer packets.

In some embodiments, the thickness of layer A of the first layer packet may be at least 1.1 times, at least 1.2 times, at least 1.5 times, or at least 2 times greater than the thickness of the layer A of the n^{th} layer packet. In some embodiments, the thickness of layer A of the first layer packet may be up to 2 times, up to 5 times, or up to 10 times greater than the thickness of layer A of the n^{th} layer packet. In an exemplary embodiment, the thickness of layer A of the first layer packet may be 3 times greater than the thickness of layer A of the n^{th} layer packet.

In some embodiments, the thickness of layer A of each layer packet decreases by at least 5 percent, at least 10 percent, at least 15 percent, at least 20 percent, at least 25 percent, or at least 30 percent from one layer packet to the next. In some embodiments, the thickness of layer A of each layer packet decreases by up to 50 percent, up to 100 percent, up to 200 percent, up to 500 percent, or up to 1000 percent from one layer packet to the next.

In some embodiments, both the thickness of the conformable layer and the thickness of layer A may be varied throughout the stack. For example, as shown in FIG. 1D, as the thickness of the conformable layer increases from the first layer to the n^{th} layer, the thickness of layer A decreases from the first layer to the n^{th} layer. Alternatively, as shown in FIG. 1E, the thickness of the conformable layer and the thickness of layer A may both increase from the first layer to the n^{th} layer. As a result, the ratio of the thickness of layer A to the thickness of the conformable layer remains constant throughout the depth of the stack. Without wishing to be bound by theory, it is believed that a thicker A layer, being semi-crystalline or mostly semi-crystalline, is stiffer and more easily initiates a peel.

The front and back major surfaces of adjacent layer packets are in intimate contact with each other, forming a packet interface. Each of the layer packets has at least two polymer layers disposed between the front and back major surfaces: one polymer layer A, and a conformable layer (which may include a single layer or layer B and layer C). As shown in the figures, layer A of a given packet is the frontmost polymer layer in the packet, and the layer B is the backmost polymer layer in the packet. The stack of layer packets may be constructed such that the frontmost polymer layer is intended to be peeled first. The backmost polymer layer may form or be attached to a workpiece. For example, the backmost polymer layer may be attached to a mask such as a face shield, a set of safety glasses, a pair of sun glasses, safety goggles, ski goggles, or another application where the removal of contamination on the surface might be beneficial. In one embodiment, the stack of layer packets is coextruded with the workpiece or a portion of a workpiece, such as the shield or lens of a face shield, safety glasses, sun glasses, safety goggles, ski goggles, or the like.

In some embodiments, the thickness of a single layer packet in the co-extruded stack of polymer layers is up to 10 micrometers, up to 25 micrometers, up to 50 micrometers, up to 75 micrometers, up to 100 micrometers, up to 125 micrometers, or up to 150 micrometers. In some embodiments, the thickness of a single layer packet in the co-extruded stack of polymer layers is at least 1 micrometer, at least 5 micrometers, at least 10 micrometers, at least 25 micrometers, at least 50 micrometers, at least 75 micrometers, at least 100 micrometers, or at least 125 micrometers.

An exemplary multilayered polymer film is shown schematically in FIG. 2A. In this exemplary embodiment, the film 210a is made up of a stack 220a of polymer layers. The film 210a is typically relatively thin and flexible such that it may be applied to, and conform to, workpieces that are contoured rather than flat. For example, the film 210a may have an overall thickness of up to 510 micrometers (about 20 mil), up to 380 micrometers (about 15 mil), up to 300 micrometers, up to 200 micrometers, up to 100 micrometers, or up to 50 micrometers. In some embodiments the film 210a may have an overall thickness of at least 25 micrometers, at least 50 micrometers, at least 100 micrometers, at least 200 micrometers, at least 300 micrometers, or at least 380 micrometers.

Alternatively, in some cases it may be desirable for the film 210a to be relatively thick and inflexible or rigid. For example, when the film is used for applications like a face shield where at least a portion of the film is unsupported, a more rigid film may be preferable. In some embodiments, the Young's modulus of the film may be at least 1 GPa, at least 2 GPa, or at least 3 GPa. In some embodiments, the Young's modulus of the film may be up to 3 GPa, up to 4 GPa, up to 5 GPa, or up to 10 GPa. (For reference, steel has a Young's modulus of about 200 GPa).

The polymer film 210a of FIG. 2A includes layer packets 222, 224, 226, and 228. Four layer packets are shown. However, the polymer film 210a may include more than four layer packets, such as up to 10, up to 15, up to 20, up to 25, or up to 30 layer packets. The layer packets are separately irreversibly peelable from a remainder of the stack.

Each layer packet (222, 224, 226, and 228) includes a layer A (242a, 242b, 242c, and 242d for layer packets 222, 224, 226, and 228, respectively) and a conformable layer (232a, 232b, 232c, 232d for layer packets 222, 224, 226, and 228, respectively). Each layer packet is characterized by a front and back major surface. Layer packet 222 has a front major surface 222a and a back major surface 222b. Layer packet 224 has a front major surface 224a (which is in intimate contact with back major surface 222b) and a back major surface 224b. Layer packet 226 has a front major surface 226a (which is in intimate contact with back major surface 224b) and a back major surface 226b. Layer packet 228 has a front major surface 228a (which is in intimate contact with back major surface 226b) and a back major surface 228b.

As used in the context of this discussion, the terms “front,” “back,” and the like (for example, frontmost, backmost) are used for convenience to specify the ordering of the layers with respect to outer major surfaces of the film or stack, and should not be construed in a limiting way. Thus, even for films or packets that are intended for use such that one outer major surface is to face outwardly (front) and the other outer major surface is to face inwardly (back), either of these outer major surfaces may be considered the “front,” and the other outer major surface would then be considered the “back.” In some embodiments, the first layer packet may be the frontmost layer packet of the co-extruded stack of polymer layers.

The polymer compositions of each layer of the layer packets are tailored such that the backmost polymer layer (for example, layer C) has a weaker attachment to the frontmost polymer layer (for example layer A) than to the interior polymer layer (for example layer b). Accordingly, the first layer packet tends to irreversibly delaminate from the second layer packet along a delamination surface corresponding to an interface between the layer packets.

For example, in some embodiments, a packet interface between layers A and C of adjacent layer packets exhibits a first peel force; a layer interface between adjacent layers A and B exhibits a second peel force that is greater than the first peel force; and a layer interface between adjacent layers B and C exhibits a third peel force that is greater than the first peel force. In some embodiments, the third peel force is greater than the second peel force.

In some embodiments, the first peel force is 0.8 grams/inch or greater, 1 gram/inch or greater, 1.5 gram/inch or greater, 2 grams/inch or greater, or 5 g/in or greater. In some embodiments, the first peel force is up to 500 g/in.

In some embodiments, the second peel force is at least 1.02 times, at least 1.04 times, at least 1.07 times, at least 1.1 times, at least 2 times, or at least 3 times the first second force. In some embodiments, the second peel force is up to 500 times the second peel force.

In some embodiments, the third peel force is at least 1.02 times, at least 1.04 times, at least 1.07 times, at least 1.1 times, at least 2 times, or at least 3 times the first peel force. In some embodiments, the third peel force is up to 500 times the first peel force.

The film of FIG. 2A is configured so that successive layer packets may be delaminated in continuous sheet form from the remaining film. The film of FIG. 2A is constructed such that the first peel force increases from the first packet interface (between the first layer packet 222 and the second layer packet 224) to the last packet interface (between the third layer packet 226 and the fourth layer packet 228). However, even with the increasing first peel force at packet interfaces, the second and third peel forces are greater than the first peel force to facilitate delamination at the packet interface.

This delamination is shown in the sequence of FIG. 2B through FIG. 2D. In FIG. 2B, the film 210a of FIG. 2A becomes a modified film 210b by the removal of the top or frontmost layer packet 222. Delamination of each layer packet may be initiated by pulling at the top layer packet. Delamination may be assisted by application of a knife or other sharp instrument to the edge of the film 210a, by the application of an adhesive tape (including, for example Scotch brand tape (3M Company, St. Paul, Minn.)) to the top layer packet, or by the use of a tab or tab-like feature, as further discussed below.

Layer packet 222 is delaminated from the remainder of the stack 220a in a continuous sheet form, such that a reduced layer stack 220b remains in place as part of the modified film 210b, as shown in FIG. 2B. Delamination occurs preferentially along a delamination surface corresponding to a packet interface between layer packet 222 and layer packet 224. After removal of the layer packet 222, the layer packet 224 becomes the outermost layer packet of the film 210b, and the front major surface 224a of layer packet 224 becomes the front major surface of the film 210b. Surface 224a is then typically exposed to air or other ambient environment. Removal of the layer packet 222 may expose a non-contaminated (or in some cases sterile) surface.

Afterwards, the outermost layer packet 224 may be removed from the film 210b to form a new modified film 210c, as shown in FIG. 2C. The layer packet 224 is delaminated from the remainder of the stack 220b in a continuous sheet form, such that a reduced layer stack 220c remains in place as part of the modified film 210c. Delamination occurs preferentially along a delamination surface corresponding to a packet interface between layer packet 224 and layer packet 226. After removal of the layer packet 224, the layer packet 226 becomes the outermost layer packet of the film 210c, and the front major surface 226a of layer packet 226 becomes the front major surface of the film 210c. Surface 226a is then typically exposed to air or other ambient environment. Removal of the layer packet 224 may expose a non-contaminated (or in some cases sterile) surface.

After the removal of layer packet 224, the now-outermost layer packet 226 may be removed from the film 210c to form a new modified film 210d, as shown in FIG. 2D. The layer packet 226 is delaminated from the remainder of the stack 220c in a continuous sheet form, such that a reduced layer stack 220d remains in place as part of the modified film 210d. Delamination occurs preferentially along a delamination surface corresponding to a packet interface between layer packet 226 and layer packet 228. After removal of the layer packet 226, the layer packet 228 becomes the outermost layer packet of the film 210d, and the front major surface 228a of layer packet 228 becomes the front major surface of the film 210d. Surface 228a is then typically exposed to air. Removal of the layer packet 226 may expose a non-contaminated (or in some cases sterile) surface.

Although the original film 210a of FIG. 2A is shown to have four layer packets, in other cases the original film may contain more than four layer packets, or, if desired, fewer than four (but at least two) layer packets.

The film of FIG. 3A, like the film of FIG. 2A, is configured so that successive layer packets may be delaminated in continuous sheet form from the remaining film. This delamination is shown in the sequence of FIG. 3B through FIG. 3E, with like numbers in FIG. 3 referring to like elements in FIG. 2. For example, FIG. 2A includes layer packets 222, 224, 226, and 228 and FIG. 3 includes layer packets 322, 324, 326, and 328. Each layer packet (322, 324, 326, and 328) includes a layer A (342a, 342b, 342c, and 342d for layer packets 322, 324, 326, and 328, respectively) and a conformable layer (332a, 332b, 332c, 332d for layer packets 322, 324, 326, and 328, respectively). Each layer packet includes a front major surface (322a, 324a, 326a, 328a for layer packets 322, 324, 326, and 328, respectively) and a back major surface (322b, 324b, 326b, 328b for layer packets 322, 324, 326, and 328, respectively).

As shown in FIG. 3A, in some embodiments, the film—such as original film 310a of FIG. 3A—may be in intimate contact with a base layer 312. For example, the back major surface 328b of layer packet 328 may be in contact with a base layer 312.

In FIG. 3B, the film 310a of FIG. 3A becomes a modified film 310b by the removal of the top or frontmost layer packet 322. In FIG. 3C, the film 310b of FIG. 3B becomes a modified film 310c by the removal of layer packet 324. In FIG. 3D, the film 310c of FIG. 3C becomes a modified film 310d by the removal of layer packet 326.

In FIG. 3E, the depicted film 310e is the same as film 310d after the complete removal of the third layer packet 326. Thus, the layer stack 320d includes only the fourth layer packet 328, which remains attached to the base layer 312. The base layer 312 may, optionally, be attached to a workpiece via an adhesive backing layer.

The fourth layer packet 328 may also be removed, and the front major surface the base layer 312 becomes the front major surface of the film 310d.

In some embodiments, the base layer may include the same polymer composition as layer A. In some embodiments, the base layer may additionally include an amorphous polymer composition miscible with the polymer composition of layer A. In an exemplary embodiment, the base layer may be or may comprise polyethylene terephthalate (PET). In some embodiments, the base layer may further comprise amorphous polyester (for example, PETg) at a level sufficient to eliminate any haze that can arise from crystallization of PET. For example, in an exemplary embodiment, the base layer may further comprise at least 5% of an amorphous polyester (PETg).

Because the polymer compositions of each layer of the layer packets are tailored such that the backmost polymer layer (for example, layer C) has a weaker attachment to the frontmost polymer layer (for example layer A) than to the interior polymer layer (for example layer b), forming a base layer from the same polymer composition as layer A means that the final layer packet may be irreversibly delaminated from the base layer along a delamination surface corresponding to an interface between the backmost surface of the final layer packet and the base layer.

In some embodiments, the base layer may be thicker than an individual layer A, layer B, or layer C. In some embodiments, the base layer may have a thickness of at least 100 micrometers, at least 150 micrometers, at least 200 micrometers, at least 250 micrometers (about 10 mil), or at least 300 micrometers. In some embodiments, the base layer may have a thickness of up to 150 micrometers, up to 200 micrometers, up to 250 micrometers (about 10 mil), up to 300 micrometers, up to 500 micrometers, or up to 1000 micrometers.

In some embodiments, the base layer may be co-extruded with the layer packets in one film construction.

To facilitate the sequential removal of only one layer packet at a time, the film 210a or 310a, as well as the other multilayered polymer films described herein, may be made with tabs at the edge of the film. For example, the polymer film may have kiss-cut tab-like features of differing depths at the edge of the film. In this regard, published international application WO 2012/092478 (Wu et al.) exemplifies ways in which laser radiation may be used to cut and subdivide polymeric multilayer film bodies without any substantial delamination at the laser cut edge lines, which may be useful in forming the desired tab-like features. The laser radiation may be selected to have a wavelength at which at least some of the materials of the film have substantial absorption so that the absorbed electromagnetic radiation may effectively vaporize or ablate the film body along the cut line. The laser radiation may also be shaped with suitable focusing optics and controlled to suitable power levels to accomplish the vaporization along a narrow cut line. The laser radiation may also be rapidly scanned across the workpiece according to pre-programmed instructions, and switched on and off rapidly so that cut lines of arbitrary shape may be followed.

In some cases it may be desirable for the layer stack to be sterilization compatible, for example by ethylene oxide or by radiation. In some embodiments, the coextruded polymer film is sterilized, for example by ethylene oxide or by radiation.

Ethylene oxide possesses the ability to penetrate paper, a number of plastics, and rubber. It is currently used to sterilize disposable syringes, hypodermic needles, prepackaged material, petri dishes, pipettes, etc. Advantages of ethylene oxide sterilization may include suitability for thermolabile substances because it can be carried out at, or only slightly above, room temperature; it does not damage moisture-sensitive substances and equipment because only a low humidity is required; it can be used for prepackaged articles because of the great penetrating capability of ethylene oxide; and although ethylene oxide is a highly reactive compound, comparatively few materials are damaged by this process.

In certain embodiments it may be desirable to sterilize the film by ionizing radiation such as gamma radiation or electron beam. In such cases, the material compositions of the film are chosen to withstand this treatment. One or more antioxidants such as hindered phenols, phosphites, and hindered amines may be added to the polymer compositions used in the film in order to increase polymer stability during sterilization. In some embodiments, the coextruded polymer film includes one or more antioxidants and is sterilized by ionizing radiation.

In addition to the gradient in peel force between the layer packets throughout the stack of polymer layers, the stack may be otherwise configured to promote irreversible delamination at packet interfaces. Examples of physical structures that would promote such delamination are described in U.S. Publication No. 2019/0248118 A1 and include a nested set of kiss-cut holes formed by mechanical blades, laser radiation, or any other suitable means.

The coextruded polymer film may include labels, indicia, or other visual or textured markings or features. For example, labels, indicia, or other markings or features may be provided on or in one or more layers of the stack.

Additionally or alternatively, markings may include holes of different depth through the stack. These holes may all open at the exposed surface of the frontmost layer and terminate at different layer packets: the shallowest hole may terminate in the frontmost layer packet, the next deepest hole may terminate in the next layer packet, the next deepest hole may terminate in the next layer packet, and so forth.

In some embodiments, various layers may be made to have different colors by incorporating dyes, pigments, or other tinting or coloring agents, such that, for example, every other layer packet (or one or more layers thereof) is a different color, or the last layer packet or last few layer packets in the stack may be colored with such dyes, pigments, etc. to provide a visible indication to the user that no more layer packets (or only one or a few layer packets) are available for delamination.

### Methods of Making

As shown in FIG. 1A, individual layers A, B, and C form a layer packet 122; and as shown in FIG. 2A and FIG. 3A, the layer packets may be coextruded together to form a stack 220a or 320a which may form all or part of a multilayered polymer film 210a or 310a. In the embodiment depicted in FIG. 1A, the layer packet 122 is composed of three types of layers: layer A 142, layer B 144, and layer C 146, which may be composed of different polymer compositions, A, B, and C, respectively. These three different layer types are organized into repeating groups of layers A, B, C, A, B, C, and so forth, the smallest repeat unit (A, B, C) defining a single layer packet. In some cases, the layer packet may include only two types of layers.

In some embodiments, it is preferable that none of the polymer compositions A, B, or C are pressure sensitive adhesives (PSAs), or other types of adhesives. An “adhesive” in this regard refers to a material or layer that, when or as applied to the surfaces of different components, binds the surfaces together and resists separation, and is tacky at room temperature. Furthermore, the polymer compositions A, B, and C are preferably coextrudable with each other, such that the entire layer stack 220a or 320a—including repeating layers of the polymer compositions A, B, and C—may be coextruded in a single operation rather than being made in different operations and then later laminated together with an adhesive.

In some cases, the multilayered polymer film may be made by coextrusion. Coextrusion may include melt processing at a temperature of at least 190° C., at least 195° C., at least 200° C., at least 200° C., at least 204° C., at least 206° C., at least 208° C., or at least 210° C.

In some cases, making the multilayered polymer film may also include one or more stretching or orienting steps. In some embodiments, layer A and layer B, or layer A and layer C, or layer B and layer C, or some combination thereof may be oriented. Such oriented layers may have a minimum level of birefringence including, for example, a birefringence of at least 0.05. As noted above, macromolecular orientation, or crystallinity, or both, in at least one component of layer A or layer B or both may affect the peel force of the A-B pair. One or more uniaxial stretching steps or on or more biaxial stretching steps in the film-making process may be used to facilitate macromolecular orientation, crystallization, or both.

The stretching, which is sometimes referred to as drawing, can be uniaxial or biaxial, and if biaxial, may be simultaneous or sequential. The act or process of stretching the multilayered film may result in all, or only some, or in some cases none of the constituent polymer layers being oriented, depending on the materials used and the process conditions such as the temperature of the film during stretch. Reference is made to U.S. Pat. No. 6,179,948 (Merrill et al.) for further discussion of known stretching or drawing techniques. For example, a two-step drawing process can be carried out in which one set of layers (for example, layer A) substantially orients during both drawing steps, while the other set of layers (for example, layer B) only substantially orients during one drawing step. The result is a multilayered film having one set of material layers that are substantially biaxially oriented after drawing, and having another set of material layers that are substantially uniaxially oriented after drawing.

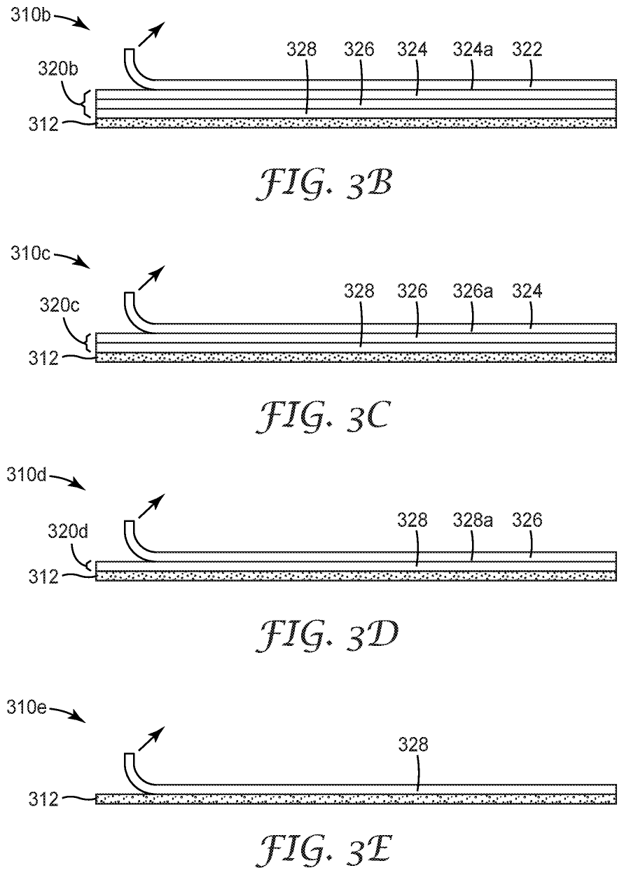

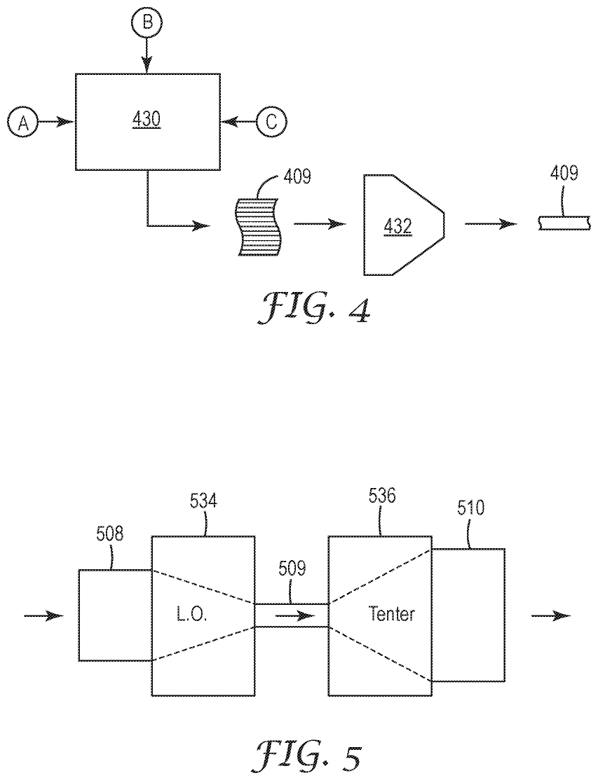

FIGS. 4 and 5 are schematic representations of manufacturing systems that can be used in the manufacture of the disclosed multilayered polymer films. FIG. 4 schematically depicts the coextrusion of polymer compositions A, B, C to form a multilayered polymer film 410. Here, the polymer compositions can be fed via twin-screw extruders or other suitable means to a feedblock 430 that interleaves the molten polymer flow paths so that they form a multilayered extrudate 409 in which the polymer layers A, B, and C are arranged in the repeating pattern desired in the finished film. In some cases, the extrudate 409 may be fed into one or more layer multiplier units to form an output extrudate having a multiple (for example, 2×, 3×, or 4×) of the number of layers in the original extrudate 409. Whether or not layer multipliers are used, the multilayered extrudate can then be fed into a film die 432, the output of which can be quenched on a casting wheel to form a cast multilayered polymer film. In some cases, the cast film may, with no additional components, become the finished multilayered polymer film 410. In other cases, additional layers and coatings may be applied to the cast film for additional functionality. For example, a release liner may be applied to one or both exposed major surfaces of the cast film. Also, an adhesive backing layer may be coated onto one of the exposed major surfaces of the cast film so that it can be readily applied to a workpiece. Regardless of how many additional layers and coatings are applied, the finished multilayered polymer film 410 includes the stack of polymer layers formed by coextrusion using the feedblock 430, optional layer multiplier(s), and die 432, the layers in the stack being organized into layer packets tailored to irreversibly delaminate from each other as discussed elsewhere herein.

In some cases, it may be desirable to stretch or orient the multilayered cast film, whether to impart a birefringence to some or all of the individual layers in the film, or to change other material properties of some or all of the individual polymer layers. Such stretching or orientation is depicted schematically in FIG. 5. A multilayered cast film 508, which may be the same as or similar to the cast film 410 of FIG. 4, and which includes at least three different polymer layer types arranged in the repeating pattern desired in the finished film, may be fed into one or more known film-handling devices that stretch the film in the down-web direction and/or in the cross-web direction, whether sequentially, simultaneously, or a combination thereof, to provide an oriented multilayered polymer film 510 with the delamination characteristics described herein. In FIG. 5, the multilayered cast film 508 is shown being fed first into a length orienter (L.O.) 534, which stretches the film in the down-web direction to provide a preliminary oriented film 509, followed by a tenter 536, which stretches the film in the cross-web direction, to yield the finished oriented multilayered polymer film 510. In alternative embodiments, the length orienter 534 may be omitted, or the tenter 536 may be omitted, or additional length orienter(s) and/or tenter(s) may be added. A tenter designed to be capable of stretching the film in both the downweb and crossweb directions simultaneously (not shown) may also be used, either alone or in combination with the aforementioned stretching devices. Specially designed tenters such as so-called parabolic tenters may also be used, alone or in combination with other stretching units. In other embodiments (not shown), the cast film may be formed into a tubular rather than flat-film configuration, and the tubular cast film may then be stretched using blown film processes or the like. The methods that can be used for stretching/orienting the cast film into a stretched film are not limited.

Similar to the discussion above in connection with FIG. 4, the finished oriented film 510 may, with no additional components, become the finished multilayered polymer film whose delamination properties are discussed herein. In other cases, additional layers and coatings, such as release liner(s) and adhesive backing layer(s), may be applied to the oriented film for additional functionality. Regardless of how many additional layers and coatings are applied, the finished multilayered polymer film includes the stack of polymer layers formed originally by coextrusion, and then optionally oriented by stretching, the layers in the stack being organized into layer packets tailored to irreversibly delaminate from each other as discussed elsewhere herein.

As a result of the polymer layers in the layer stack being preferably compatible with simultaneous formation by coextrusion, as depicted in FIG. 4, the individually peelable layer packets can be made thinner than if they were manufactured separately and then laminated to each other. Preferably, each of the layer packets in the stack may have a thickness of no more than about 2 mils (about 50 microns). Furthermore, the layer stack may contain a total of n layer packets, and n may be at least 5 or at least 10, and the film may have an overall thickness of no more than about 15 or 20 mils (about 380 or 510 microns respectively). At least n−1 of the layer packets may have a same number m of the polymer layers, and m may be at least 3. The m polymer layers may be arranged in a sequence that is the same for the n−1 layer packets or for all n layer packets.

In one approach to tailoring the attachment strength of one polymer layer to other polymer layers in the layer stack, a polymer composition composed of a blend of polypropylene and one of several copolymer resins exhibits an attachment strength to other polypropylene layers that is a function of the proportion of the blended ingredients. This approach is discussed in more detail in U.S. Publication No. 2019/0248817.

### Methods of Using

A multilayered polymer film as described herein may be tailored for a variety of purposes and for a variety of end-use applications. In some cases, the film may be an anti-graffiti film. In some cases, the film may be used as a cover for a mask such as a face shield, a set of safety glasses, a pair of sun glasses, safety goggles, ski goggles, and other applications where the removal of contamination on the surface of the mask, glasses, or goggles by the removal of a film might be beneficial. In some embodiments, the film may be used as a cover for a high-touch surface in a hospital, laboratory, school, hotel, restaurant, or other setting where the ability to remove a contaminated surface and expose a sterile surface would be beneficial

In some embodiments, the film, and, if included, a base layer, may be substantially transparent, so that the workpiece to which it is applied does not change its appearance or its functionality regardless of how much of the original film is present on the workpiece at any given time. In some embodiments, the film, and, if included, a base layer, may have a haze of up to 2 percent, up to 3 percent, up to 4 percent, or up to 5 percent. In some embodiments, the film, and, if included, a base layer, may have a transmission of at least 70 percent, at least 75 percent, at least 80 percent, at least 85 percent, or at least 90 percent. In some embodiments, the film, and, if included, a base layer, may have a clarity of at least 80 percent, at least 85 percent, at least 90 percent, at least 95 percent, or at least 99 percent. In some embodiments, haze and transmission are measured using ASTM D1003-13. In some embodiments, clarity is measuring using ASTM D3430-95(2016).

In other embodiments, for example, when transparency is not important, transmission may be as low as 0%, haze as high as 100%, and clarity as low as 0%.

In some embodiments, a multilayered polymer film as described herein may be used to provide a sterile, substantially germ-free environment. In this regard, a benefit of making the individual polymer layers and layer packets in a single coextrusion operation, rather than in separate manufacturing operations that involve handling, alignment, and lamination of separately manufactured films, is that the front major surfaces of the layer packets may be much more easily maintained in a non-contaminated (for example, sterile) state, until they are exposed by the peeling away of the layer packets in front of a given layer packet.

In some embodiments, a multilayered polymer film as described herein may be used to provide a controlled surface topography at a workpiece. For example, it may be desired to effectively provide a workpiece with a high quality smooth (low roughness) surface finish. Rather than polishing the surface of the workpiece itself, a film may be applied to the workpiece to provide the needed smooth surface. In use, as the outer surface of the film becomes abraded or otherwise non-smooth, a layer packet may be peeled away to restore the desired smooth surface.

In other embodiments, a controlled degree of roughness may be desired at a workpiece. In such cases, a controlled amount of suitably sized beads or other particles may be provided in the frontmost polymer layer of each layer packet, so that the frontmost (exposed) surface of the film has the desired amount of surface roughness. If the exposed surface should become worn down, abraded, contaminated with other materials, or the like, the desired surface roughness can be easily restored by simply peeling off the outermost layer packet to uncover the pristine surface of the immediately adjacent layer packet, which again has the desired surface roughness.

### Face Shield

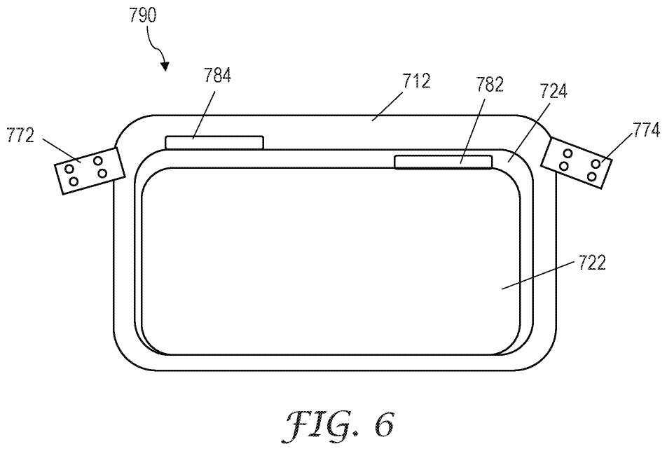

An exemplary embodiment in which the film is used as a cover for a face shield 790 is shown in FIG. 6. A base layer 712 may be co-extruded with the layer packets 722 and 724 in one film construction. Alternatively, the film may include layer packets 722 and 724 which are attached to a workpiece via an adhesive backing layer. FIG. 6 shows a face shield 790 that includes two layer packets, but the face shield may include a stack of polymer layers that includes any suitable number of layer packets.

In some embodiments, as shown in FIG. 6, the layer packets 722 and 724 include tabs 782 and 784 to facilitate sequential removal of only one layer packet at a time. The tabs 782, 784 may be of differing depths at the edge of each layer packet. The tabs 782, 784 may be formed by any suitable process, such as a kiss-cut process. In this regard, published international application WO 2012/092478 (Wu et al.) exemplifies ways in which laser radiation may be used to cut and subdivide polymeric multilayer film bodies without any substantial delamination at the laser cut edge lines, which may be useful in forming the desired tabs.

In some embodiments, the face shield 790 is sterilization compatible, for example by ethylene oxide or by radiation. In some embodiments, the face shield 790 is sterilized, for example by ethylene oxide or by radiation.

In some embodiments, as shown in FIG. 6, the base layer 712 includes straps, tabs, or a pin pattern 772, 774 to allow the face shield to be connected to a mounting assembly, such as a crown.

In some embodiments, the base layer 712 includes the same polymer composition as layer A. In some embodiments, the base layer may additionally include an amorphous polymer composition miscible with the polymer composition of layer A. In an exemplary embodiment, the base layer 712 may be or may comprise polyethylene terephthalate (PET). In some embodiments, the base layer 712 may further comprise amorphous polyester (PETg) at a level sufficient to eliminate any haze that can arise from crystallization of PET. For example, in an exemplary embodiment, the base layer 712 may further comprise at least 5% amorphous polyester (PETg).

In an exemplary embodiment, the thickness of at least some of the layers of the layer packets in the face shield 790 varies successively from the frontmost layer packet to the backmost layer packet. For example, the thickness of the conformable layer (for example, combined layers B and C) may increase successively from the first layer packet (for example, layer packet 722) to the second layer packet (for example, layer packet 724) and in subsequent layer packets. The thickness of layer A may decrease successively from the first layer packet (for example, layer packet 722) to the second layer packet (for example, layer packet 724) and in subsequent layer packets.

In an exemplary embodiment, layer A includes polymer composition A including a polyester, a copolyester, an acrylic, or a silicone thermoplastic, or a combination thereof; layer B includes polymer composition B including a copolyester, PMMA, co-PMMA, a styrenic block copolymer, polypropylene, or silicone polyoxamides, or a combination thereof; and layer C includes polymer composition C including an olefin, or a styrenic block copolymer, or a combination thereof. For example, polymer composition A may include polyethylene terephthalate (PET) and polymer compositions B and C may include a copolymer based on styrene and ethylene/butylene including, for example, KRATON G1645 (Kraton Corporation, Houston, Tex.), a linear, triblock copolymer based on styrene and ethylene/butylene.

In an exemplary embodiment, the face shield including a base layer exhibit a haze of up to 5%, a transmission of at least 85%, and a clarity of at least 95%, as measured using ASTM D1003-13 (for transmission and haze and ASTM D3430-95(2016) (for clarity).

### Exemplary Film Aspects Comprising Variable Thickness of the Conformable Layer

1. A film comprising:

a co-extruded stack of polymer layers, the polymer layers being organized into layer packets, each layer packet comprising a first layer A, a second layer B, and a third layer C, layer B being disposed between layer A and layer C;

a packet interface between layers A and C of adjacent layer packets, the packet interface exhibiting a first peel force of 1 gram/inch or greater;

a layer interface between adjacent layers A and B, the layer interface exhibiting a second peel force that is greater than the first peel force; and

a layer interface between adjacent layers B and C, the layer interface exhibiting a third peel force that is greater than the first peel force;

wherein the layer packets are separately irreversibly peelable from a remainder of the stack; and

wherein the co-extruded stack of polymer layers comprises at least a first layer packet and a second layer packet, each layer packet comprising a conformable layer comprising layer B and layer C, the thickness of the conformable layer of the second layer packet being greater than the thickness of the conformable layer of the first layer packet.

2. The film of Aspect 1, wherein the co-extruded stack of polymer layers comprises n layer packets, and wherein the co-extruded stack of polymer layers exhibits a peel force gradient from the first layer packet to the n^{th} layer packet, or a gradient in the thickness of the conformable layer from the first layer packet to the n^{th} layer packet, or both a peel force gradient and a thickness gradient.

3. The film of Aspect 2, wherein the peel force at the packet interface between layer A of the second layer packet and layer C of the first layer packet is less than the peel force between layer A of an n^{th} layer packet and layer C of an (n−1)^{th} layer packet.

4. The film of Aspect 3, wherein the peel force at the packet interface between layer A of the second layer packet and layer C of the first layer packet is at least 5, at least 10, at least 100, or at least 250 times less than the peel force between layer A of an n^{th} layer packet and layer C of an (n−1)^{th} layer packet.

5. The film of Aspect 3 or 4, wherein the peel force at the packet interface between layer A of the second layer packet and layer C of the first layer packet is up to 500, up to 250, up to 100, or up to 10 times less than the peel force between layer A of an n^{th} layer packet and layer C of an (n−1)^{th} layer packet.

6. The film of any one of Aspects 3 to 5, wherein the peel force at each successive packet interface increases by at least 0.5 percent, at least 1 percent, at least 5 percent, at least 10 percent, at least 20 percent, at least 50 percent, or at least 100 percent.

7. The film of any one of Aspects 3 to 6, wherein the peel force at each successive packet interface increases by up to 1 percent, up to 5 percent, up to 10 percent, up to 20 percent, up to 50 percent, up to 100 percent, up to 1000 percent, up to 10,000 percent, or up to 50,000 percent.

8. The film of any one of Aspects 2 to 7, wherein the thickness of the conformable layer of the first layer packet is at least 1.1 times, at least 1.2 times, at least 1.5 times, or at least 2 times less than the thickness of the conformable layer of the n^{th} layer packet.

9. The film of any one of Aspects 2 to 8, wherein the thickness of the conformable layer of the first layer packet is up to 2 times, up to 5 times, or up to 10 times less than the thickness of the conformable layer of the n^{th} layer packet

10. The film of any one of Aspects 2 to 9, wherein the thickness of the conformable layer of each successive layer packet increases by at least 15 percent, at least 20 percent, at least 25 percent, or at least 30 percent.

11. The film of any one of Aspects 2 to 10, wherein the thickness of the conformable layer of each successive layer packet increases by up to 50 percent, up to 100 percent, up to 200 percent, up to 500 percent, or up to 1000 percent.

12. The film of any one of the preceding Aspects, wherein the peel force at the packet interface between layer C of the first layer packet and layer A of the second layer packet is less than a peel force between layer C of an n^{th} layer packet and a base layer.

13. The film of any one of Aspects 2 to 12, wherein the n^{th} layer packet is the second, third, fourth, fifth, sixth, seventh, eighth, ninth, tenth, eleventh, twelfth, thirteenth, fourteenth, fifteenth, sixteenth, seventeenth, eighteenth, nineteenth, twentieth, or twenty-first layer packet.

14. The film of any one of the preceding Aspects, wherein layer A comprises a first polymer composition A, layer B comprises a second polymer composition B, and layer C comprises a third polymer composition C.

15. The film of Aspect 14, wherein polymer composition B is different from polymer composition A, and polymer composition C is different from polymer composition A.

16. The film of Aspect 15, wherein polymer composition C is different from polymer composition B.

17. The film of any one of Aspects 14 to 16, wherein the polymer compositions A, B, and C independently comprise one or more polymers selected from polyesters, polyolefins, poly-alpha-olefins, polymethacrylates, polycarbonates, polycarbonate alloys, polyurethanes, polylactic acid, polyhydroxybutyrate, polyhydroxysuccinate, styrenic copolymers, silicones, or copolymers or blends thereof.

18. The film of any one of Aspects 14 to 17, wherein polymer composition A comprises a semi-crystalline polyester.

19. The film of any one of Aspects 14 to 18, wherein polymer composition B comprises a copolyester, or a styrenic block copolymer, or a combination thereof

20. The film of any one of Aspects 14 to 19, wherein polymer composition C comprises an olefin, or a styrenic block copolymer, or a combination thereof.

21. The film of any one of Aspects 14 to 20, wherein polymer composition C is at least partially miscible with polymer composition B and polymer composition B is at least partially miscible with polymer composition A, and polymer composition C is not miscible with the first polymer composition.

22. The film of any one of Aspects 14 to 21, wherein the film further comprises a base layer, the base layer comprising the same polymer composition as layer A.

23. The film of Aspect 22, wherein the base layer further comprises an amorphous polymer composition miscible with the polymer composition of layer A.

24. The film of any one of the preceding Aspects, wherein layer A, layer B, or layer C, or a combination thereof comprises one or more additives.

25. The film of any one of the preceding Aspects, wherein layer A, layer B, or layer C, or a combination thereof comprises one or more ultraviolet (UV) light stabilizers.

26. The film of any one of the preceding Aspects, wherein layer A, layer B, or layer C, or a combination thereof comprises one or more organic antimicrobial agents.

27. The film of any one of the preceding Aspects, wherein layer A and layer B, or layer A and layer C, or layer B and layer C, or a combination thereof are oriented and have a birefringence of at least 0.5.

28. The film of any one of the preceding Aspects, wherein each of the layer packets in the co-extruded stack of polymer layers has a thickness of up to 10 micrometers, up to 25 micrometers, up to 50 micrometers.

29. The film of any one of the preceding Aspects, wherein each of the layer packets in the co-extruded stack of polymer layers has a thickness of at least 1 micrometer, at least 5 micrometers, or at least 10 micrometers.

30. The film of any one of the preceding Aspects, wherein the second peel force is at least 1.04 times the first peel force.

31. The film of any one of the preceding Aspects, wherein the second peel force is up to 500 times the first peel force.

32. The film of any one of the preceding Aspects, wherein the third peel force is at least 1.1 times the first peel force.

33. The film of any one of the preceding Aspects, wherein the third peel force is up to 500 times the first peel force.

34. The film of any one of the preceding Aspects, wherein the third peel force is at least 1.04 times the second peel force.

35. The film of any one of the preceding Aspects, wherein the third peel force is up to 500 times the second peel force.

36. The film of any one of the preceding Aspects, wherein the first peel force is up to 500 grams/inch.

37. The film of any one of the preceding Aspects, wherein the overall thickness of the film is up to 510 micrometers, up to 380 micrometers, up to 300 micrometers, up to 200 micrometers, up to 100 micrometers, or up to 50 micrometers.

38. The film of any one of the preceding Aspects, wherein the overall thickness of the film is at least 25 micrometers, at least 50 micrometers, at least 100 micrometers, at least 200 micrometers, at least 300 micrometers, or at least 380 micrometers.

39. The film of any one of the Aspects 2 to 38, wherein the thickness of layer A is held constant from the first layer packet to the n^{th} layer packet.

40. The film of any one of the Aspects 2 to 38, wherein the co-extruded stack of polymer layers comprises a gradient in the thickness of the layer A from the first layer packet to the n^{th} layer packet.

41. The film of Aspect 40, wherein the thickness of layer A of the first layer packet is greater than the thickness of layer A of the n^{th} layer packet.

42. The film of Aspect 40, wherein the thickness of layer A of the first layer packet is less than the thickness of layer A of the n^{th} layer packet.

43. The film of Aspect 42, wherein the ratio of the thickness of layer A to the thickness of the conformable layer remains constant throughout the depth of the stack.

Exemplary Film Aspects Comprising Variable Thickness of the Layer A

1. A film comprising:

a co-extruded stack of polymer layers, the polymer layers being organized into layer packets, each layer packet comprising a first layer A, a second layer B, and a third layer C, layer B being disposed between layer A and layer C;

a packet interface between layers A and C of adjacent layer packets, the packet interface exhibiting a first peel force of 1 gram/inch or greater; and

a layer interface between adjacent layers A and B, the layer interface exhibiting a second peel force that is greater than the first peel force;

a layer interface between adjacent layers B and C, the layer interface exhibiting a third peel force that is greater than the first peel force;

wherein the layer packets are separately irreversibly peelable from a remainder of the stack; and

wherein the co-extruded stack of polymer layers comprises at least a first layer packet and a second layer packet, and wherein the thickness of layer A of the second layer packet is less than the thickness of layer A of the first layer packet.

2. The film of Aspect 1, wherein the co-extruded stack of polymer layers comprises n layer packets, and wherein the co-extruded stack of polymer layers exhibits a peel force gradient from the first layer packet to the n^{th} layer packet, or a gradient in the thickness of the layer A from the first layer packet to the n^{th} layer packet, or both a peel force gradient and a thickness gradient.

3. The film of Aspect 2, wherein the peel force at the packet interface between layer A of the second layer packet and layer C of the first layer packet is less than the peel force between layer A of an n^{th} layer packet and layer C of an (n−1)^{th} layer packet.

4. The film of Aspect 3, wherein the peel force at the packet interface between layer A of the second layer packet and layer C of the first layer packet is at least 5, at least 10, at least 100, or at least 250 times less than the peel force between layer A of an n^{th} layer packet and layer C of an (n−1)^{th} layer packet.

5. The film of Aspect 3 or 4, wherein the peel force at the packet interface between layer A of the second layer packet and layer C of the first layer packet is up to 500, up to 250, up to 100, or up to 10 times less than the peel force between layer A of an n^{th} layer packet and layer C of an (n−1)^{th} layer packet.

6. The film of any one of Aspects 3 to 5, wherein the peel force at each successive packet interface increases by at least 0.5 percent, at least 1 percent, at least 5 percent, at least 10 percent, at least 20 percent, at least 50 percent, or at least 100 percent.

7. The film of any one of Aspects 3 to 6, wherein the peel force at each successive packet interface increases by up to 1 percent, up to 5 percent, up to 10 percent, up to 20 percent, up to 50 percent, up to 100 percent, up to 1000 percent, up to 10,000 percent, or up to 50,000 percent.

8. The film of any one of Aspects 2 to 7, wherein the thickness of the layer A of the first layer packet is at least 1.1 times, at least 1.2 times, at least 1.5 times, or at least 2 times greater than the thickness of the layer A of the n^{th} layer packet.

9. The film of any one of Aspects 2 to 8, wherein the thickness of the layer A of the first layer packet is up to 2 times, up to 5 times, or up to 10 times greater than the thickness of the layer A of the n^{th} layer packet

10. The film of any one of Aspects 2 to 9, wherein the thickness of layer A in each successive layer packet decreases by at least 15 percent, at least 20 percent, at least 25 percent, or at least 30 percent.

11. The film of any one of Aspects 2 to 10, wherein the thickness of layer A in each successive layer packet decreases by up to 50 percent, up to 100 percent, up to 200 percent, up to 500 percent, or up to 1000 percent.

12. The film of any one of the preceding Aspects, wherein the peel force at the packet interface between layer C of the first layer packet and layer A of the second layer packet is less than a peel force between layer C of an n^{th} layer packet and a base layer.

13. The film of any one of Aspects 2 to 12, wherein the n^{th} layer packet is the second, third, fourth, fifth, sixth, seventh, eighth, ninth, tenth, eleventh, twelfth, thirteenth, fourteenth, fifteenth, sixteenth, seventeenth, eighteenth, nineteenth, twentieth, or twenty-first layer packet.

14. The film of any one of the preceding Aspects, wherein layer A comprises a first polymer composition A, layer B comprises a second polymer composition B, and layer C comprises a third polymer composition C.

15. The film of Aspect 14, wherein polymer composition B is different from polymer composition A, and polymer composition C is different from polymer composition A.

16. The film of Aspect 15, wherein polymer composition C is different from polymer composition B.

17. The firm of any one of Aspects 14 to 16, wherein the polymer compositions A, B, and C independently comprise one or more polymers selected from polyesters, polyolefins, poly-alpha-olefins, polymethacrylates, polycarbonates, polycarbonate alloys, polyurethanes, polylactic acid, polyhydroxybutyrate, polyhydroxysuccinate, styrenic copolymers, silicones, or copolymers or blends thereof.

18. The film of any one of Aspects 14 to 17, wherein polymer composition A comprises a semi-crystalline polyester.

19. The film of any one of Aspects 14 to 18, wherein polymer composition B comprises a copolyester, or a styrenic block copolymer, or a combination thereof

20. The film of any one of Aspects 14 to 19, wherein polymer composition C comprises an olefin, or a styrenic block copolymer, or a combination thereof.

21. The film of any one of Aspects 14 to 20, wherein polymer composition C is at least partially miscible with polymer composition B and polymer composition B is at least partially miscible with polymer composition A, and polymer composition C is not miscible with the first polymer composition.

22. The film of any one of Aspects 14 to 21, wherein the film further comprises a base layer, the base layer comprising the same polymer composition as layer A.

23. The film of Aspect 22, wherein the base layer further comprises an amorphous polymer composition miscible with the polymer composition of layer A.

24. The film of any one of the preceding Aspects, wherein layer A, layer B, or layer C, or a combination thereof comprises one or more additives.

25. The film of any one of the preceding Aspects, wherein layer A, layer B, or layer C, or a combination thereof comprises one or more ultraviolet (UV) light stabilizers.

26. The film of any one of the preceding Aspects, wherein layer A, layer B, or layer C, or a combination thereof comprises one or more organic antimicrobial agents.

27. The film of any one of the preceding Aspects, wherein layer A and layer B, or layer A and layer C, or layer B and layer C, or a combination thereof are oriented and have a birefringence of at least 0.5.

28. The film of any one of the preceding Aspects, wherein each of the layer packets in the co-extruded stack of polymer layers has a thickness of up to 10 micrometers, up to 25 micrometers, up to 50 micrometers.

29. The film of any one of the preceding Aspects, wherein each of the layer packets in the co-extruded stack of polymer layers has a thickness of at least 1 micrometer, at least 5 micrometers, or at least 10 micrometers.

30. The film of any one of the preceding Aspects, wherein the second peel force is at least 1.04 times the first peel force.

31. The film of any one of the preceding Aspects, wherein the second peel force is up to 500 times the first peel force.

32. The film of any one of the preceding Aspects, wherein the third peel force is at least 1.1 times the first peel force.

33. The film of any one of the preceding Aspects, wherein the third peel force is up to 500 times the first peel force.

34. The film of any one of the preceding Aspects, wherein the third peel force is at least 1.04 times the second peel force.

35. The film of any one of the preceding Aspects, wherein the third peel force is up to 500 times the second peel force.

36. The film of any one of the preceding Aspects, wherein the first peel force is up to 500 grams/inch.

37. The film of any one of the preceding Aspects, wherein the overall thickness of the film is up to 510 micrometers, up to 380 micrometers, up to 300 micrometers, up to 200 micrometers, up to 100 micrometers, or up to 50 micrometers.

38. The film of any one of the preceding Aspects, wherein the overall thickness of the film is at least 25 micrometers, at least 50 micrometers, at least 100 micrometers, at least 200 micrometers, at least 300 micrometers, or at least 380 micrometers.

39. The film of any one of the Aspects 2 to 38, wherein each layer packet comprises a conformable layer comprising layer B and layer C, and the thickness of the conformable layer is held constant from the first layer packet to the n^{th} layer packet.

40. The film of any one of the Aspects 2 to 38, wherein each layer packet comprises a conformable layer comprising layer B and layer C, and the wherein the co-extruded stack of polymer layers comprises a gradient in the thickness of the conformable layer from the first layer packet to the n^{th} layer packet.

41. The film of Aspect 40, wherein the thickness of the conformable layer of the first layer packet is less than the thickness of layer A of the n^{th} layer packet.

42. The film of Aspect 41, wherein the ratio of the thickness of layer A to the thickness of the conformable layer remains constant throughout the depth of the stack.

Exemplary Film Aspects Comprising Polymer Compositions

1. A film comprising:

a co-extruded stack of polymer layers, the polymer layers being organized into layer packets, each layer packet comprising a first layer A, a second layer B, and a third layer C, layer B being disposed between layer A and layer C;

wherein layer A of the film comprises a first polymer composition A, layer B of the film comprises a second polymer composition B, and layer C of the film comprises a third polymer composition C;

wherein polymer composition A comprises a polyester, a co-polyester, a polyolefin, a poly-alpha-olefin, a polymethacrylate, a polycarbonate, a polycarbonate alloy, a polyurethane, an aliphatic polyester, polyhydroxybutyrate, polyhydroxysuccinate, a styrenic copolymer, a silicone, a silicone thermoplastic, an acrylic, or a copolymer or blend thereof;

wherein polymer composition B comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;

wherein polymer composition C comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;

wherein the layer packets are separately irreversibly peelable from a remainder of the stack; and

wherein the co-extruded stack of polymer layers comprises at least a first layer packet and a second layer packet, each layer packet comprising a conformable layer comprising layer B and layer C, the thickness of the conformable layer of the second layer packet being greater than the thickness of the conformable layer of the first layer packet.

2. A film comprising:

a co-extruded stack of polymer layers, the polymer layers being organized into layer packets, each layer packet comprising a first layer A, a second layer B, and a third layer C, layer B being disposed between layer A and layer C;

wherein layer A of the film comprises a first polymer composition A, layer B of the film comprises a second polymer composition B, and layer C of the film comprises a third polymer composition C;

wherein polymer composition A comprises a polyester, a co-polyester, a polyolefin, a poly-alpha-olefin, a polymethacrylate, a polycarbonate, a polycarbonate alloy, a polyurethane, an aliphatic polyester, polyhydroxybutyrate, polyhydroxysuccinate, a styrenic copolymer, a silicone, a silicone thermoplastic, an acrylic, or a copolymer or blend thereof;

wherein polymer composition B comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;

wherein polymer composition C comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;

wherein the layer packets are separately irreversibly peelable from a remainder of the stack; and

wherein the co-extruded stack of polymer layers comprises at least a first layer packet and a second layer packet, wherein the thickness of layer A of the second layer packet is less than the thickness of layer A of the first layer packet.

3. The film of Aspect 1 or 2, wherein polymer composition A comprises a polyester, a copolyester, an acrylic, or a silicone thermoplastic, or a combination thereof;

wherein polymer composition B comprises a copolyester, PMMA, co-PMMA, a styrenic block copolymer, polypropylene, or silicone polyoxamides, or a combination thereof;

wherein polymer composition C comprises an olefin, or a styrenic block copolymer, or a combination thereof.

4. The film of any one of the preceding Aspects, wherein the film further comprises

a packet interface between layers A and C of adjacent layer packets, the packet interface exhibiting a first peel force of 1 gram/inch or greater;

a layer interface between adjacent layers A and B, the layer interface exhibiting a second peel force that is greater than the first peel force; and

a layer interface between adjacent layers B and C, the layer interface exhibiting a third peel force that is greater than the first peel force.

5. The film of any one of the preceding Aspects, wherein polymer composition A comprises a semi-crystalline polyester.

6. The film of any one of the preceding Aspects, wherein polymer composition A comprises polyethylene terephthalate (PET).

7. The film of any one of the preceding Aspects, wherein polymer composition B comprises a copolyester, or a styrenic block copolymer, or a combination thereof.

8. The film of any one of the preceding Aspects, wherein polymer composition B comprises a copolymer based on styrene and ethylene/butylene.

9. The film of any one of the preceding Aspects, wherein polymer composition C comprises a copolymer based on styrene and ethylene/butylene.

10. The film of any one of the preceding Aspects, wherein the peel force at the packet interface between layer A of the second layer packet and layer C of the first layer packet is less than the peel force between layer A of an n^{th} layer packet and layer C of an (n−1)^{th} layer packet.

11. The film of Aspect 10, wherein the peel force at the packet interface between layer A of the second layer packet and layer C of the first layer packet is at least 5, at least 10, at least 100, or at least 250 times less than the peel force between layer A of an n^{th} layer packet and layer C of an (n−1)^{th} layer packet.

12. The film of Aspect 10 or 11, wherein the peel force at the packet interface between layer A of the second layer packet and layer C of the first layer packet is up to 500, up to 250, up to 100, or up to 10 times less than the peel force between layer A of an n^{th} layer packet and layer C of an (n−1)^{th} layer packet.

13. The film of any one of the preceding Aspects, wherein the peel force at each successive packet interface increases by at least 0.5 percent, at least 1 percent, at least 5 percent, at least 10 percent, at least 20 percent, at least 50 percent, or at least 100 percent.

14. The film of any one of the preceding Aspects, wherein the peel force at each successive packet interface increases by up to 1 percent, up to 5 percent, up to 10 percent, up to 20 percent, up to 50 percent, up to 100 percent, up to 1000 percent, up to 10,000 percent, or up to 50,000 percent.

15. The film of any one of the preceding Aspects, wherein the peel force at the packet interface between layer C of the first layer packet and layer A of the second layer packet is less than a peel force between layer C of an n^{th} layer packet and a base layer.

16. The film of any one of Aspects 10 to 15, wherein the n^{th} layer packet is the second, third, fourth, fifth, sixth, seventh, eighth, ninth, tenth, eleventh, twelfth, thirteenth, fourteenth, fifteenth, sixteenth, seventeenth, eighteenth, nineteenth, twentieth, or twenty-first layer packet.

17. The film of any one the preceding Aspects, wherein polymer composition C is at least partially miscible with polymer composition B and polymer composition B is at least partially miscible with polymer composition A, and polymer composition C is not miscible with the first polymer composition.

18. The film of any one the preceding Aspects, wherein the film further comprises a base layer, the base layer comprising the same polymer composition as layer A.

19. The film of Aspect 18, wherein the base layer further comprises an amorphous polymer composition miscible with the polymer composition of layer A.

20. The film of any one of the preceding Aspects, wherein layer A, layer B, or layer C, or a combination thereof comprises one or more additives.

21. The film of any one of the preceding Aspects, wherein layer A, layer B, or layer C, or a combination thereof comprises one or more ultraviolet (UV) light stabilizers.

22. The film of any one of the preceding Aspects, wherein layer A, layer B, or layer C, or a combination thereof comprises one or more organic antimicrobial agents.

23. The film of any one of the preceding Aspects, wherein layer A and layer B, or layer A and layer C, or layer B and layer C, or a combination thereof are oriented and have a birefringence of at least 0.5.

24. The film of any one of the preceding Aspects, wherein each of the layer packets in the co-extruded stack of polymer layers has a thickness of up to 10 micrometers, up to 25 micrometers, up to 50 micrometers.

25. The film of any one of the preceding Aspects, wherein each of the layer packets in the co-extruded stack of polymer layers has a thickness of at least 1 micrometer, at least 5 micrometers, or at least 10 micrometers.

26. The film of any one of the preceding Aspects, wherein the second peel force is at least 1.04 times the first peel force.

27. The film of any one of the preceding Aspects, wherein the second peel force is up to 500 times the first peel force.

28. The film of any one of the preceding Aspects, wherein the third peel force is at least 1.1 times the first peel force.

29. The film of any one of the preceding Aspects, wherein the third peel force is up to 500 times the first peel force.

30. The film of any one of the preceding Aspects, wherein the third peel force is at least 1.04 times the second peel force.

31. The film of any one of the preceding Aspects, wherein the third peel force is up to 500 times the second peel force.

32. The film of any one of the preceding Aspects, wherein the first peel force is up to 500 grams/inch.

33. The film of any one of the preceding Aspects, wherein the overall thickness of the film is up to 510 micrometers, up to 380 micrometers, up to 300 micrometers, up to 200 micrometers, up to 100 micrometers, or up to 50 micrometers.

34. The film of any one of the preceding Aspects, wherein the overall thickness of the film is at least 25 micrometers, at least 50 micrometers, at least 100 micrometers, at least 200 micrometers, at least 300 micrometers, or at least 380 micrometers.

35. The film of any one of Aspects 1 or 3 to 34, wherein the thickness of layer A is held constant from the first layer packet to an n^{th} layer packet.

36. The film of any one of the Aspects 1 or 3 to 34, wherein the co-extruded stack of polymer layers comprises a gradient in the thickness of the layer A from the first layer packet to the n^{th} layer packet.

37. The film of Aspect 36, wherein the thickness of layer A of the first layer packet is greater than the thickness of layer A of the n^{th} layer packet.

38. The film of Aspect 36, wherein the thickness of layer A of the first layer packet is less than the thickness of layer A of the n^{th} layer packet.

39. The film of Aspect 38, wherein the ratio of the thickness of layer A to the thickness of the conformable layer remains constant throughout the depth of the stack

40. The film of any one of Aspects 2 to 34, wherein each layer packet comprises a conformable layer comprising layer B and layer C, and wherein the thickness of the conformable layer is held constant from the first layer packet to the n^{th} layer packet.

### Face Shield Aspects

1. A face shield comprising the film of any one of the Film Claims.

2. The face shield of Aspect 1 further comprising a face shield base.

3. The face shield of Aspect 2, wherein the face shield base and the film are co-extruded.

4. The face shield of any one of the preceding Aspects, wherein layer A of the film comprises a first polymer composition A, layer B of the film comprises a second polymer composition B, and layer C of the film comprises a third polymer composition C, and further wherein the face shield base comprises the polymer composition A.

5. The face shield of Aspect 4, wherein the face shield comprises a face shield base, the face shield base further comprising an amorphous polymer composition miscible with the polymer composition of layer A.

6. The face shield of Aspect 4 or Aspect 5, wherein polymer composition B and polymer composition C are the same.

7. The face shield of any one of Aspects 4 to 6, wherein polymer composition A comprises polyethylene terephthalate (PET).

8. The face shield of Aspect 7, wherein the face shield base further comprises amorphous polyethylene terephthalate (PET).

9. The face shield of any one of Aspects 2 to 8, wherein the face shield base has a thickness of at least 100 micrometers, at least 150 micrometers, at least 200 micrometers, at least 250 micrometers, or at least 300 micrometers.

10. The face shield of any one of Aspects 2 to 9, wherein the face shield base has a thickness of up to 150 micrometers, up to 200 micrometers, up to 250 micrometers, up to 300 micrometers, up to 500 micrometers, or up to 1000 micrometers.

11. The face shield of any one of the preceding Aspects, wherein the layer packets comprise tabs.

12. The face shield of any one of the preceding Aspects, wherein the face shield further comprises a crown protector.

13. The face shield of any one of Aspects 2 to 12, wherein the face shield and the face shield base exhibit a haze of up to 5%, a transmission of at least 85%, and a clarity of at least 95%.

14. The face shield of any one of Aspects 2 to 12, wherein the layer packets of the face shield comprise kiss-cut tabs.

15. The face shield of any one of the preceding Aspects, wherein layer A of the film comprises a first polymer composition A, layer B of the film comprises a second polymer composition B, and layer C of the film comprises a third polymer composition C;

wherein polymer composition A comprises a polyester, a co-polyester, a polyolefin, a poly-alpha-olefin, a polymethacrylate, a polycarbonate, a polycarbonate alloy, a polyurethane, an aliphatic polyester, polyhydroxybutyrate, polyhydroxysuccinate, a styrenic copolymer, a silicone, a silicone thermoplastic, an acrylic, or a copolymer or blend thereof;

wherein polymer composition B comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;

wherein polymer composition C comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof.

16. The face shield of any one of the preceding Aspects, wherein polymer composition A comprises a polyester, a copolyester, an acrylic, or a silicone thermoplastic, or a combination thereof;

wherein polymer composition B comprises a copolyester, PMMA, co-PMMA, a styrenic block copolymer, polypropylene, or silicone polyoxamides, or a combination thereof,

wherein polymer composition C comprises an olefin, or a styrenic block copolymer, or a combination thereof.

17. The face shield of any one of the preceding Aspects, wherein composition A comprises polyethylene terephthalate (PET).

18. The face shield of any one of the preceding Aspects, wherein polymer composition B comprises a copolyester, or a styrenic block copolymer, or a combination thereof.

19. The face shield of any one of the preceding Aspects, wherein polymer composition B comprises a copolymer based on styrene and ethylene/butylene.

20. The face shield of any one of the preceding Aspects, wherein polymer composition C comprises a copolymer based on styrene and ethylene/butylene.

The present invention is illustrated by the following examples. It is to be understood that the particular examples, materials, amounts, and procedures are to be interpreted broadly in accordance with the scope and spirit of the invention as set forth herein.

### EXAMPLES

All reagents, starting materials, and solvents used in the following examples were purchased from commercial suppliers (such as Sigma Aldrich, St. Louis, Mo.) and were used without further purification unless otherwise indicated.

### Example 1

A film stack was prepared using 3 extruders feeding into a single, 16 layer feedblock attached to a 13″ wide die. One extruder fed polyester (PET) resin to feed the 6 PET layers (A layers). Another extruder fed 5 layers of a “Tie Layer” (layer B) material (Kraton G1645 (Kraton Corporation, Houston, Tex.), a linear triblock copolymer based on styrene and ethylene/butylene). Another extruder fed 5 layers of a “Peel Layer” (C layer) material (a blend of polypropylene (PP) and KRATON G1645 (Kraton Corporation, Houston, Tex.), a linear triblock copolymer based on styrene and ethylene/butylene, used at a ratio of 9:1 (PP:KRATON)).

The feedblock was designed to feed the 6 PET layers at a uniform thickness. However, the feedblock was designed to increase the thickness of the combined “Tie” and “Peel” layers (that is, layers B and C or the “conformable layer”) throughout the stack, such that the thickest conformable layer is three times as thick as the thinnest conformable layer.

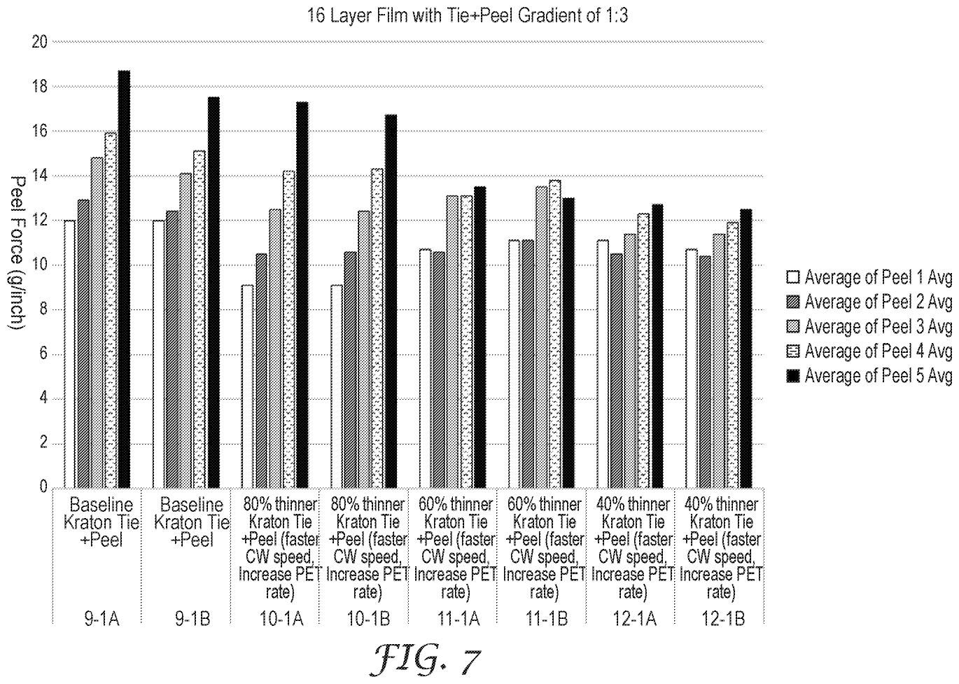

Results are shown in FIG. 7. The predicted layer thickness of each conformable layer of the samples is shown in Table 1. The measured layer thickness of each conformable layer of the samples is shown in Table 2. Layer A was designed to maintain a 9.5 micron thickness throughout the depth of the stack.

A distinct peel force increase or decrease was observed depending on the direction of the gradient. Lower peel forces correlated with the thinner end of the gradient and the higher peel forces correlated with the thicker end of the gradient.

As shown in FIG. 7, with increasing thickness of the conformable layer, an increasing peel force from packet to packet was observed as the thickness of each conformable layer increased. In addition, as the total thickness of the conformable layer increased (i.e. the sum of all conformable layers in each film sample), the peel force difference from packet to packet became more apparent.

Using the data in the Tables, the combination of layer thickness and peel force suggests that a 20% change in conformable layer thickness is enough to provide approximately 0.5 On (that is, an approximate 0.5 percent) difference in peel force.

A gradient where the thickest conformable layer is more than three times as thick as the thinnest conformable layer could provide an even greater difference in peel force from “ABC” layer packet to “ABC” layer packet.

TABLE 1
Predicted Layer Thickness

| | | Sample 10-1 | Sample 11-1 | Sample 12-1 |
|---|---|---|---|---|
| “BC” Layer | Sample 9-1 | (80% | (60% | (40% |
| Pair (thin to | (Baseline) | thinner) | thinner) | thinner) |
| thick) | mil | mil | mil | mil |
| 1 | 0.25 | 0.2 | 0.15 | 0.125 |
| 2 | 0.375 | 0.3 | 0.225 | 0.1875 |
| 3 | 0.5 | 0.4 | 0.3 | 0.25 |
| 4 | 0.625 | 0.5 | 0.375 | 0.3125 |
| 5 | 0.75 | 0.6 | 0.45 | 0.375 |
| Layer Sum | 2.5 | 2.0 | 1.5 | 1.0 |
| (mil) | | | | |

TABLE 2
Measured Layer Thickness

| | | Sample 10-1 | Sample 11-1 | Sample 12-1 |
|---|---|---|---|---|
| “BC” Layer | Sample 9-1 | (80% | (60% | (40% |
| Pair (thin to | (Baseline) | thinner) | thinner) | thinner) |
| thick) | mil | mil | mil | mil |
| 1 | N/A | 0.245 | 0.236 | 0.174 |
| 2 | N/A | 0.328 | 0.289 | 0.228 |
| 3 | N/A | 0.433 | 0.371 | 0.276 |
| 4 | N/A | 0.534 | 0.451 | 0.345 |
| 5 | N/A | 0.674 | 0.594 | 0.429 |
| Layer Sum | N/A | 2.21 | 1.94 | 1.45 |
| (mil) | | | | |
| Calculated | N/A | 2.75 | 2.51 | 2.47 |
| gradient | | | | |

### Comparative Example 1

A film stack was prepared as described in Example 1 except a different feedblock was used. As in Example 1, the feedblock was designed to feed the 6 PET layers at a uniform thickness. In contrast to Example 1, the feedblock was designed to extrude the 5 Tie Layers at a uniform thickness throughout the stack, and the 5 Peel layers at a uniform thickness throughout the stack. The nominal thickness of each PET layer was ˜10 um thick. The nominal thickness of each Tie+Peel layer (that is, layers B and C or the “conformable layer”) was ˜11 um.

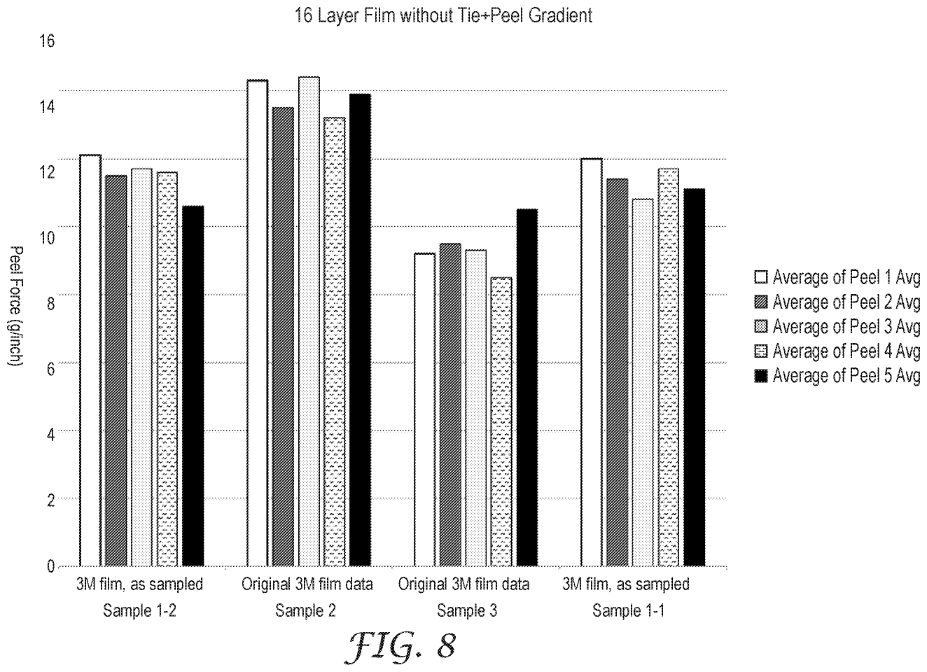

Results are shown in FIG. 8.

The complete disclosure of all patents, patent applications, and publications, and electronically available material cited herein are incorporated by reference. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A film comprising:
a co-extruded stack of polymer layers, the polymer layers being organized into layer packets, each layer packet comprising a first layer A, a second layer B, and a third layer C, layer B being disposed between layer A and layer C;
a packet interface between layers A and C of adjacent layer packets, the packet interface exhibiting a first peel force of 1 gram/inch or greater;
a layer interface between adjacent layers A and B, the layer interface exhibiting a second peel force that is greater than the first peel force; and
a layer interface between adjacent layers B and C, the layer interface exhibiting a third peel force that is greater than the first peel force;
wherein the layer packets are separately irreversibly peelable from a remainder of the stack; and
wherein the co-extruded stack of polymer layers comprises at least a first layer packet and a second layer packet, each layer packet comprising a conformable layer comprising layer B and layer C, the thickness of the conformable layer of the second layer packet being greater than the thickness of the conformable layer of the first layer packet.

2. A film comprising:
a co-extruded stack of polymer layers, the polymer layers being organized into layer packets, each layer packet comprising a first layer A, a second layer B, and a third layer C, layer B being disposed between layer A and layer C;
a packet interface between layers A and C of adjacent layer packets, the packet interface exhibiting a first peel force of 1 gram/inch or greater; and
a layer interface between adjacent layers A and B, the layer interface exhibiting a second peel force that is greater than the first peel force;
a layer interface between adjacent layers B and C, the layer interface exhibiting a third peel force that is greater than the first peel force;
wherein the layer packets are separately irreversibly peelable from a remainder of the stack; and
wherein the co-extruded stack of polymer layers comprises at least a first layer packet and a second layer packet, and wherein the thickness of layer A of the second layer packet is less than the thickness of layer A of the first layer packet.

3. A film comprising:
a co-extruded stack of polymer layers, the polymer layers being organized into layer packets, each layer packet comprising a first layer A, a second layer B, and a third layer C, layer B being disposed between layer A and layer C;
wherein layer A of the film comprises a first polymer composition A, layer B of the film comprises a second polymer composition B, and layer C of the film comprises a third polymer composition C;
wherein polymer composition A comprises a polyester, a co-polyester, a polyolefin, a poly-alpha-olefin, a polymethacrylate, a polycarbonate, a polycarbonate alloy, a polyurethane, an aliphatic polyester, polyhydroxybutyrate, polyhydroxysuccinate, a styrenic copolymer, a silicone, a silicone thermoplastic, an acrylic, or a copolymer or blend thereof;
wherein polymer composition B comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;
wherein polymer composition C comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;
wherein the layer packets are separately irreversibly peelable from a remainder of the stack; and
wherein the co-extruded stack of polymer layers comprises at least a first layer packet and a second layer packet, each layer packet comprising a conformable layer comprising layer B and layer C, the thickness of the conformable layer of the second layer packet being greater than the thickness of the conformable layer of the first layer packet.

4. A film comprising:
a co-extruded stack of polymer layers, the polymer layers being organized into layer packets, each layer packet comprising a first layer A, a second layer B, and a third layer C, layer B being disposed between layer A and layer C;
wherein layer A of the film comprises a first polymer composition A, layer B of the film comprises a second polymer composition B, and layer C of the film comprises a third polymer composition C;
wherein polymer composition A comprises a polyester, a co-polyester, a polyolefin, a poly-alpha-olefin, a polymethacrylate, a polycarbonate, a polycarbonate alloy, a polyurethane, an aliphatic polyester, polyhydroxybutyrate, polyhydroxysuccinate, a styrenic copolymer, a silicone, a silicone thermoplastic, an acrylic, or a copolymer or blend thereof;
wherein polymer composition B comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;
wherein polymer composition C comprises a polyester, a polyolefin, a poly-alpha-olefin, a polymethacrylate, a polycarbonate, a polycarbonate alloy, an aliphatic polyester, a polyethylene succinate, a polylactic acid, a styrenic block copolymer, a silicone, or a copolymer or blend thereof;
wherein the layer packets are separately irreversibly peelable from a remainder of the stack; and
wherein the co-extruded stack of polymer layers comprises at least a first layer packet and a second layer packet, wherein the thickness of layer A of the second layer packet is less than the thickness of layer A of the first layer packet.

5. A face shield comprising the film of claim 1.

6. A face shield comprising the film of claim 2.

7. A face shield comprising the film of claim 3.

8. A face shield comprising the film of claim 4.
